(19) United States
(12) Patent Application Publication
(10) Pub. No.: US 2026/0123811 A1
(43) Pub. Date: May 7, 2026

(54) CLEANING APPARATUS, CLEANING DEVICE AND CLEANING SYSTEM

(71) Applicant: Beijing Roborock Technology Co., Ltd., Beijing (CN)

(72) Inventors: Zhiwei ZHOU, Beijing (CN); Bainian ZHAO, Beijing (CN)

(21) Appl. No.: 19/436,486

(22) Filed: Dec. 30, 2025

Related U.S. Application Data
(63) Continuation of application No. PCT/CN2024/108570, filed on Jul. 30, 2024.

(30) Foreign Application Priority Data
Jun. 28, 2024 (CN) 202410867273.X
Jun. 28, 2024 (CN) 202410868427.7
Jun. 28, 2024 (CN) 202410868465.2
Jun. 28, 2024 (CN) 202421524604.1
Jun. 28, 2024 (CN) 202421526220.3
Jun. 28, 2024 (CN) 202421530255.4

(51) Int. Cl. A47L 11/40; F16H 1/22

(52) U.S. Cl. CPC A47L 11/4069; A47L 11/4041; F16H 1/22

(57) ABSTRACT

A cleaning apparatus includes a housing, a plurality of cleaning members and a driving mechanism. The plurality of cleaning members is installed in the housing. The driving mechanism is in direct or transmission connection with the plurality of cleaning members and is configured to drive the plurality of cleaning members to perform a motion relative to the housing, at least one driving member is disposed on the housing, and the number of the at least one driving member is smaller than the number of the cleaning members.

### CROSS-REFERENCE TO RELATED APPLICATION(S)

The present application is a continuation of PCT application No. PCT/CN2024/108570 filed on Jul. 30, 2024, which claims priority to Chinese Patent Application No. 202410867273.X, Chinese Patent Application No. 202421524604.1, Chinese Patent Application No. 202410868427.7, Chinese Patent Application No. 202421526220.3, Chinese Patent Application No. 202410868465.2 and Chinese Patent Application No. 202421530255.4, filed on Jun. 28, 2024, all of which are incorporated herein by reference in their entireties as a part of the present application.

### TECHNICAL FIELD

The present disclosure belongs to the technical field of cleaning devices and in particular relates to a cleaning apparatus, a cleaning device and a cleaning system.

### BACKGROUND ART

Cleaning apparatuses usually perform cleaning operations through the rotation of cleaning members. However, if a plurality of cleaning members are disposed, a plurality of driving mechanisms need to be disposed correspondingly to drive different cleaning members to operate respectively, resulting in a too large volume of the entire cleaning apparatus.

In addition, since the cleaning apparatuses usually perform cleaning operations through the rotation of cleaning members, during operation of the cleaning members, impurities such as hair are prone to wind the cleaning members, and thus it is difficult to clean or replace the cleaning members.

### SUMMARY

Embodiments of the present disclosure provide a cleaning apparatus. The cleaning apparatus includes:
a housing;
a plurality of cleaning members all installed in the housing; and
a driving mechanism in direct or transmission connection with the cleaning members, wherein the driving mechanism is configured to drive the plurality of cleaning members to perform a motion relative to the housing, and includes at least one driving member, wherein the driving member is disposed on the housing, and the number of the at least one driving member is smaller than the number of the cleaning members.

### BRIEF DESCRIPTION OF THE DRAWINGS

In order to describe the technical solutions in the embodiments of the present disclosure more clearly, the following briefly introduces the accompanying drawings required for describing the embodiments. Apparently, the accompanying drawings in the following description show some embodiments of the present disclosure, and those of ordinary skill in the art may also derive other drawings from these accompanying drawings without creative efforts.

FIG. 1 shows a stereoscopic structural schematic diagram of a cleaning apparatus when a cleaning member is in a detachment state according to an embodiment of the present disclosure;

FIG. 2 shows a stereoscopic structural schematic diagram of a cleaning apparatus when the cleaning member is in a working state according to an embodiment of the present disclosure;

FIG. 3 shows an exploded view of a support and a housing of a cleaning apparatus according to an embodiment of the present disclosure;

FIG. 4 shows an enlarged view of the portion B in FIG. 3;

FIG. 5 shows a schematic diagram of an internal structure of a cleaning apparatus according to an embodiment of the present disclosure;

FIG. 6 shows a stereoscopic structural schematic diagram of a cleaning apparatus according to an embodiment of the present disclosure;

FIG. 7 shows an enlarged view of the portion C in FIG. 6;

FIG. 8 shows an enlarged view of the portion A in FIG. 1;

FIG. 9 shows an exploded view of a cover body and the housing of a cleaning apparatus according to an embodiment of the present disclosure;

FIG. 10 shows a schematic diagram of an assembly relationship of a driving member and a transmission member of a cleaning apparatus according to an embodiment of the present disclosure;

FIG. 11 shows a stereoscopic structural schematic diagram of a supporting member of a cleaning apparatus according to an embodiment of the present disclosure;

FIG. 12 shows a sectional view of a cleaning member, the supporting member and the support of a cleaning apparatus according to an embodiment of the present disclosure;

FIG. 13 shows another stereoscopic structural schematic diagram of the supporting member of a cleaning apparatus according to an embodiment of the present disclosure;

FIG. 14 shows a schematic diagram of an assembly relationship of the supporting member and the support of a cleaning apparatus according to an embodiment of the present disclosure;

FIG. 15 shows another stereoscopic structural schematic diagrams of a cleaning apparatus when a cleaning member is in the detachment state according to an embodiment of the present disclosure;

FIG. 16 shows another stereoscopic structural schematic diagram of a cleaning apparatus according to an embodiment of the present disclosure;

FIG. 17 shows a schematic diagram of an internal structure of a first transmission member of a cleaning apparatus according to an embodiment of the present disclosure;

FIG. 18 shows an enlarged view of the portion D in FIG. 16;

FIG. 19 shows a schematic diagram of an internal structure of a second transmission member of a cleaning apparatus according to an embodiment of the present disclosure;

FIG. 20 shows a stereoscopic structural schematic diagram of an output wheel of a cleaning apparatus according to an embodiment of the present disclosure;

FIG. 21 shows to a still another stereoscopic structural schematic diagram of a cleaning apparatus when a cleaning member is in the detachment state according to an embodiment of the present disclosure;

FIG. 22 shows a stereoscopic structural schematic diagram of a housing of a cleaning apparatus according to an embodiment of the present disclosure;

FIG. 23 shows a stereoscopic structural schematic diagram of a cleaning member according to an embodiment of the present disclosure;

FIG. 24 shows a stereoscopic structural schematic diagram of a cleaning apparatus when a support is at a second position according to an embodiment of the present disclosure;

FIG. 25 shows an enlarged view of the portion A in FIG. 24;

FIG. 26 shows a stereoscopic structural schematic diagram of a cleaning apparatus when a support is at a first position according to an embodiment of the present disclosure;

FIG. 27 shows another stereoscopic structural schematic diagram of a cleaning apparatus when a support is at a second position according to an embodiment of the present disclosure;

FIG. 28 shows still another stereoscopic structural schematic diagram of a cleaning apparatus when a support is at a second position according to an embodiment of the present disclosure;

FIG. 29 shows a further stereoscopic structural schematic diagram of a cleaning apparatus when a cleaning member is in a detachment state according to an embodiment of the present disclosure;

FIG. 30 shows another stereoscopic structural schematic diagram of a cleaning apparatus when a cleaning member is in a working state according to an embodiment of the present disclosure;

FIG. 31 shows a still further stereoscopic structural schematic diagram of a cleaning apparatus when a cleaning member is in a detachment state according to an embodiment of the present disclosure;

FIG. 32 shows another exploded view of a support and a housing of a cleaning apparatus according to an embodiment of the present disclosure;

FIG. 33 shows an enlarged view of the portion B in FIG. 32;

FIG. 34 shows another schematic diagram of the internal structure of a cleaning apparatus according to an embodiment of the present disclosure;

FIG. 35 shows still another stereoscopic structural schematic diagram of a cleaning apparatus according to an embodiment of the present disclosure;

FIG. 36 shows an enlarged view of the portion A in FIG. 31;

FIG. 37 shows an enlarged view of the portion A in FIG. 31; and

FIG. 38 shows an enlarged view of the portion C in FIG. 35.

### REFERENCE SIGNS IN THE FIGURES

100. housing; 110. accommodating groove; 120. movable shaft; 130. fixing groove; 131. first side wall; 132. second side wall; 140. positioning groove; 141. first guide surface; 150. dust collection opening; 160. installation groove; 170. extending part;
200. driving part;
300. support; 310. base; 320. connecting lug; 321. matching groove; 330. second guide surface; 340. connecting part; 360. positioning part;
400. cleaning member; 410. matching protrusion; 411. matching hole; 412. first matching surface; 413. second matching surface; 420. free end; 430. fixed end;
500. cover body; 510. working window;
600. supporting member; 610. stop member; 611. first stop surface; 612. assembling guide surface; 613. detachment guide surface; 620. rebound space; 630. rotating head; 640. limiting part; 650. sliding groove;
700. transmission member; 710. input wheel; 720. output wheel; 721. embedding groove; 730. first transmission member; 731. first input wheel; 732. first output wheel; 740. second transmission member; 741. second input wheel; 742. second output wheel; and
800. linkage member.

### DETAILED DESCRIPTION

Technical solutions in embodiments of the present disclosure will be clearly and completely described below with reference to the accompanying drawings in the embodiments of the present disclosure. Obviously, the embodiments described are merely some but not all embodiments of the present disclosure. Based on the embodiments of the present disclosure, all other embodiments derived by those of ordinary skill in the art without creative efforts should fall within the protection scope of the present disclosure.

In addition, the present disclosure may repeat reference numerals and/or reference letters in different examples, and such repetition is for the purpose of simplicity and clarity and not in itself indicative of a relationship between various embodiments and/or arrangements discussed herein. In addition, various examples of specific processes and materials are provided in the present disclosure, but those of ordinary skill in the art may realize the application of other processes and/or the use of other materials.

Cleaning apparatuses usually perform cleaning operations through the rotation of cleaning members. However, if a plurality of cleaning members are disposed, a plurality of driving mechanisms need to be disposed correspondingly to drive different cleaning members to operate respectively, resulting in a too large volume of the entire cleaning apparatus.

The present disclosure is described below with reference to the accompanying drawings and example embodiments.

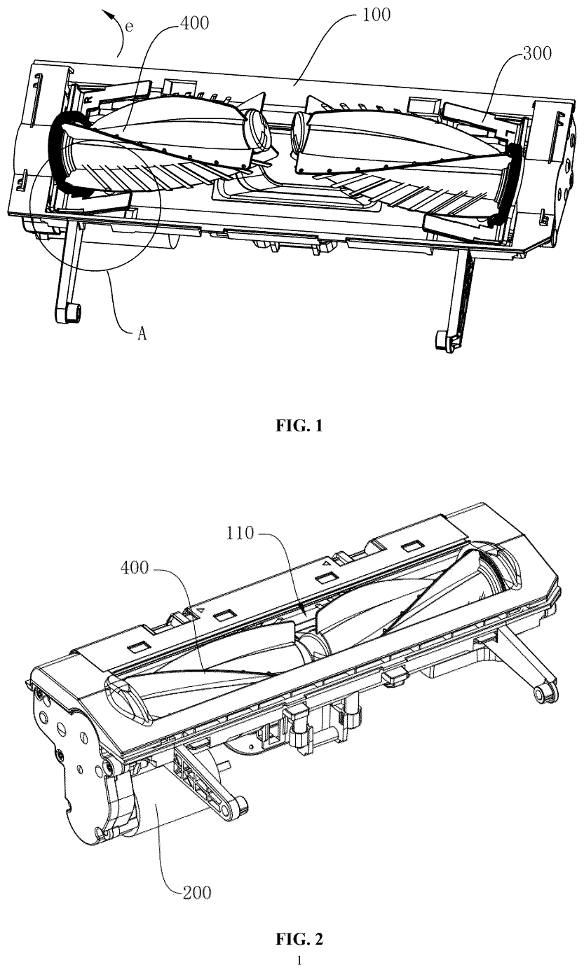

Embodiments of the present disclosure provide a cleaning apparatus. Referring to FIG. 1, the cleaning apparatus includes a housing 100, a plurality of cleaning members 400 and a driving mechanism. The plurality of cleaning members 400 are all installed in the housing 100. The driving mechanism is in direct connection or in transmission connection with the cleaning members 400 and is configured to drive the plurality of cleaning members 400 to perform a motion relative to the housing 100.

Since the plurality of cleaning members 400 are disposed, the effective cleaning area of the cleaning members 400 can be increased, thereby improving a cleaning effect of the cleaning members 400. By driving a larger number of cleaning members 400 by a smaller number of driving member(s) 200 to perform a motion relative to the housing 100, the number of the driving member(s) 200 can be reduced and thus an occupied space of the driving member(s) 200 can be reduced, so that the layout of the cleaning apparatus is more compact, thereby minimizing the volume of the cleaning apparatus. Since a smaller number of driving member(s) 200 drive a larger number of cleaning members 400, the overall weight of the driving member(s) 200 can be reduced and thus it is convenient to move the cleaning apparatus. The occupied space of the driving member(s) 200 is reduced by reducing the number of the driving members 200, and the cost of the driving member(s) 200 can be reduced by reducing the number of the driving member(s) 200.

The driving mechanism is configured to drive the plurality of cleaning members 400 to perform a motion relative to the housing 100. The motion includes rotating, reciprocating, vibrating and the like. The embodiments of the present disclosure are described by taking a case where the driving mechanism is configured to drive the plurality of cleaning members 400 to rotate relative to the housing 100 as an example.

A driving member 200 may be disposed on the housing 100, and the cleaning member(s) 400 performs(perform) a motion relative to the housing 100 under the action of the driving member 200.

Referring to FIG. 1 and FIG. 2, the cleaning apparatus provided by the embodiments of the present disclosure includes a support 300. A cleaning member 400 is installed on the support 300. The support 300 is movable between a first position and a second position. The cleaning member 400 is connected to a driving shaft of a driving member 200 when the support 300 is at the first position. The cleaning member 400 is separated from the driving shaft of the driving member 200 when the support 300 moves to the second position, and the cleaning member 400 is separable from the support 300 when the support 300 is at the second position.

By switching the support 300 between the first position and the second position, the cleaning member 400 switches between a working state and a detachment state. The cleaning member 400 is connected to the driving shaft of the driving member 200 when the support 300 is at the first position, so that the cleaning member 400 rotates relative to the housing 100 under the action of the driving member 200 to complete cleaning operations. The cleaning member 400 is separable from the support 300 when the support 300 is at the second position, so that the cleaning member 400 is removed for replacement or cleaning. When the support 300 moves to the second position, since the cleaning member 400 is separated from the driving shaft of the driving member 200, the situation that an operator is accidentally injured because the cleaning member 400 works when the cleaning member 400 is detached can be prevented, thereby improving the safety performance.

In the embodiments of the present disclosure, the cleaning member 400 can quickly switch between the working state and the detachment state through the movement of the support 300. By installing the cleaning member 400 on the support 300, the cleaning member 400 can be moved outside an installation position through simple rotation of the support 300, so that the detachment operation of the cleaning member 400 does not need to be limited to a narrow installation position. The installation position of a cleaning member 400 is a position where the cleaning member 400 is located when the cleaning member 400 rotates relative to the housing 100 under the action of a driving member 200.

The cleaning member 400 is separated from the driving shaft of the driving member 200 when the support 300 moves to the second position. That is, when the cleaning member 400 enters the detachment state, the cleaning member 400 is disengaged from the driving shaft of the driving member 200, thereby preventing the situation that the cleaning member 400 rotates relative to the housing 100 under the driving of the driving mechanism in the detachment state, and reducing the risk of accidentally injuring the operator when the cleaning member 400 is detached. Through the movement of the support 300, the cleaning member 400 switches between the working state and the detachment state and meanwhile the cleaning member 400 is quickly connected to or separated from the driving member 200, so that the operation safety is improved.

The cleaning member 400 is separable from the support 300 when the support 300 is at the second position, and at this time, the cleaning member 400 can be removed for replacement or cleaning. Similarly, when the support 300 is at the second position, the cleaned cleaning member 400 or a new cleaning member 400 can be installed on the support 300, and the installation of the cleaning member 400 can be completed by moving the support 300.

The driving member 200 is disposed on the housing 100, and the cleaning member 400 rotates relative to the housing 100 under the action of the driving member 200. Shaking of the cleaning member 400 during working is reduced by fixing the driving member 200 through the housing 100.

The cleaning member 400 may be a cleaning brush, a rolling mopping cloth or the like.

In some embodiments, referring to FIG. 1 and FIG. 2, the housing is provided with an accommodating groove 110 for the cleaning member 400, and the support 300 rotates in a direction from the inside of the accommodating groove 110 to the outside of the accommodating groove 110 (such the direction e in FIG. 1). Through the rotation of the support 300, the cleaning member 400 moves from the inside of the accommodating groove 110 to the outside of the accommodating groove 110, so that the space limitation during detachment is reduced, thereby avoiding collision with an inner wall of the accommodating groove 110 or other parts inside the accommodating groove 110 when the cleaning member 400 is detached, and reducing the difficulty in detachment. When the cleaning member 400 is in the working state, a part of the cleaning member 400 is located in the accommodating groove 110; that is, the accommodating groove 110 is the installation position of the cleaning member 400. The accommodating groove 110 provides physical protection for the cleaning member 400, and meanwhile the accommodating groove 110 provides necessary mechanical support and firmness for the cleaning member 400, so that the cleaning member 400 can rotate at a proper position.

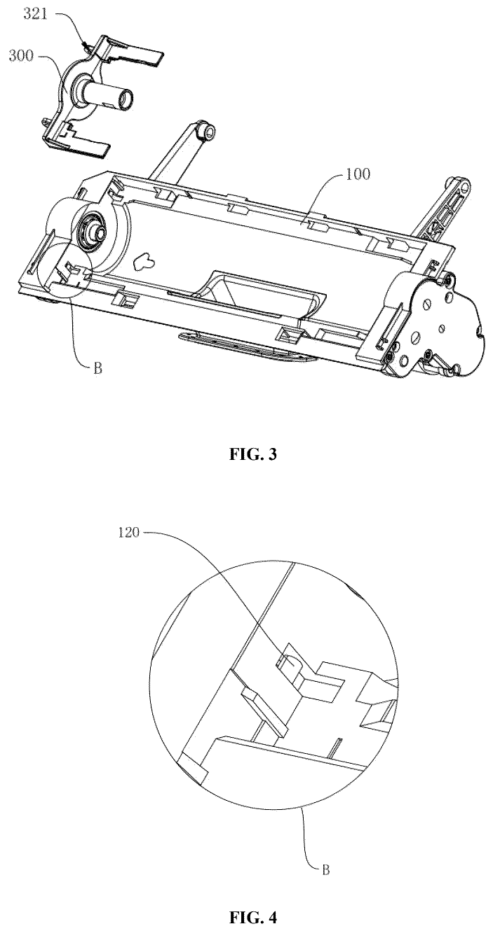

In some embodiments, one of the support 300 and the housing 100 is provided with a movable shaft 120, and the other one of the support 300 and the housing 100 is provided with a matching groove. The movable shaft 120 moves inside the matching groove 321 so that the support 300 switches between the first position and the second position. For example, referring to FIG. 3 and FIG. 4, the housing 100 is provided with the movable shaft 120 and the support 300 is provided with the matching groove 321.

The movable shaft 120 moves inside the matching groove 321 to achieve relative displacement between the support 300 and the housing 100, so that the support 300 switches between the first position and the second position. During rotating of the support 300, the movable shaft 120 is limited to be located in the matching groove 321, that is, a cooperative relationship is always kept between the support 300 and the housing 100. The cleaning member 400 can be moved outside the installation position through rotation of the support 300, thereby facilitating the detachment of the cleaning member 400. When the support 300 is moved to the first position, the cleaning member 400 installed on the support 300 can be moved to the installation position, so that the detached cleaning member 400 can be quickly and accurately installed to the installation position, thereby increasing the installing speed of the cleaning member 400.

Of course, in other embodiments, it may be the case that the support 300 is provided with the movable shaft 120 and the housing 100 is provided with the matching groove 321, and embodiments of the present disclosure do not impose specific limitations on this.

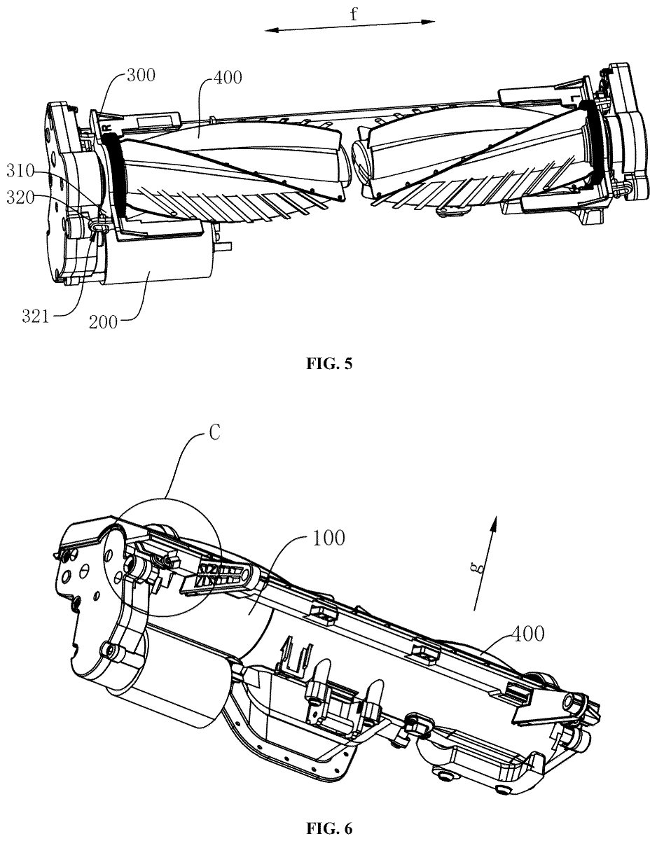

In some embodiments, referring to FIG. 5, the matching groove 321 extends along a direction of a rotating axis of a cleaning member 400 (such as the direction f in FIG. 5), so that the cleaning member is rotatable around the movable shaft 120 when the movable shaft 120 moves inside the matching groove 321, and the cleaning members on the left and right sides do not interfere with each other when the cleaning members are disposed obliquely upward. Thus, the cleaning members 400 on the support 300 may be close to or away from the driving member 200 to connect the cleaning members 400 to the driving shaft of the driving member 200 or separate the cleaning members 400 from the driving shaft of the driving member 200.

In some embodiments, referring to FIG. 5, an end of the matching groove 321 is provided with an arc-shaped inner wall so as to fit an arc-shaped outer surface of the movable shaft 120, and thus it is convenient for the support 300 to rotate by taking the movable shaft 120 as a rotation center.

In some embodiments, referring to FIG. 5 and FIG. 6, an end of the matching groove 321 away from the cleaning member 400 is inclined towards a direction away from the housing 100 (such as the direction g in FIG. 6), so that the end of the matching groove 321 away from the cleaning member 400 can match a rotating path of the support 300 and thus the rotating procedure of the support 300 can be more smooth.

In some embodiments, referring to FIG. 5 and FIG. 6, the support 300 includes a base 310 and a connecting lug 320. The connecting lug 320 is disposed on the base 310 in a protruding manner. The matching groove 321 is formed in the connecting lug 320, so that the position of the matching groove 321 can be determined quickly during installation, thereby increasing the installation speed. In addition, compared with the situation that the matching groove 321 is formed in the base 310, the connecting lug 320 is disposed on the base 310 in a protruding manner in the embodiments of the present disclosure, so that advantageously the support 300 can avoid the housing 100 or other parts disposed on the housing 100 when rotating. Thus, the rotation of the support 300 is relatively flexible.

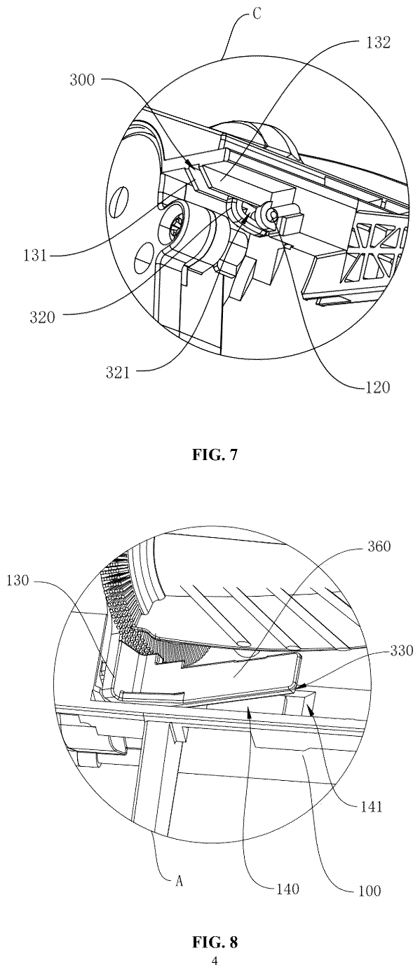

In some embodiments, referring to FIG. 6 and FIG. 7, a fixing groove 130 for the connecting lug 320 is formed in the housing 100, so that the connecting lug 320 is limited in the fixing groove 130 and thus the shaking of the connecting lug 320 is reduced when the support 300 rotates, thereby improving the rotating reliability of the support 300. The movable shaft 120 penetrates through a side wall of the fixing groove 130, so that when the connecting lug 320 moves inside the fixing groove 130, the movable shaft 120 moves inside the matching groove 321 to achieve cooperation between the movable shaft 120 and the matching groove 321. For example, the fixing groove 130 is provided with a first side wall 131 and a second side wall 132 which are opposite to each other, the connecting lug 320 is located between the first side wall 131 and the second side wall 132, and the rotating axis sequentially penetrates through the first side wall 131, the matching groove 321 and the second side wall 132. When the connecting lug 320 moves between the first side wall 131 and the second side wall 132, relative displacement occurs between the movable shaft 120 and the matching groove 321, so that the support 300 switches between the first position and the second position. Two connecting lugs 320 may be disposed to ensure the rotation reliability of the support 300. The number of the connecting lugs 320 is not limited in the embodiments of the present disclosure.

In some embodiments, referring to FIG. 8, the housing 100 is provided with a positioning groove 140, the support 300 is provided with a positioning part 360, and the positioning part 360 is at least partially located in the positioning groove 140 when the support 300 is located at the first position. The positioning groove 140 restricts the movement of the positioning part 360, so that the support 300 is kept at the first position to ensure the normal operation of the cleaning member 400. The positioning part 360 may be partially or completely located in the positioning groove 140 as long as the positioning groove 140 can restrict the movement of the positioning part 360. The positioning groove 140 may match the positioning part 360 in shape so as to better fix the positioning part 360.

The positioning part 360 is connected onto the base 310 and the positioning groove 140 may be communicated with the fixing groove 130, thereby facilitating manufacturing. Two positioning parts 360 may be disposed, and the two positioning parts 360 can improve the fixing effect on the support 300.

In some embodiments, referring to FIG. 8, the positioning groove 140 is provided with a first guide surface 141, and the support 300 slides out of the positioning groove 140 through the first guide surface 141. Through the relative sliding between the first guide surface 141 and the positioning part 360, the difficulty for the support 300 to slide out of the positioning groove 140 can be reduced, thereby facilitating switching of the support 300 from the first position to the second position. The first guide surface 141 may be an arc-shaped surface or an inclined surface, and the embodiments of the present disclosure do not specially limit the specific shape of the first guide surface 141. The first guide surface 141 is disposed at a side of the positioning groove 140 away from the rotation center of the support 300, that is, the first guide surface 141 is disposed at a side of the positioning groove 140 away from the matching groove 321.

In some embodiments, referring to FIG. 8, the positioning part 360 is provided with a second guide surface 330, and the support 300 slides out of the positioning groove 140 through the second guide surface 330. Through the relative sliding between the second guide surface 330 and the positioning groove 140, the difficulty for the support 300 to slide out of the positioning part 360 can be reduced, thereby facilitating switching of the support 300 from the first position to the second position. The second guide surface 330 may be an arc-shaped surface or an inclined surface, and the embodiments of the present disclosure do not specially limit the specific shape of the second guide surface 330. The second guide surface 330 is disposed at a side of the positioning part 360 away from the rotation center of the support 300; that is, the second guide surface 330 is disposed at a side of the positioning part 360 away from the movable shaft 120.

In some embodiments, referring to FIG. 8, the positioning groove 140 is provided with the first guide surface 141, and the positioning part 360 is provided with the second guide surface 330. Through the relative sliding between the first guide surface 141 and the second guide surface 330, the difficulty for the support 300 to slide out of the positioning groove 140 can be reduced, thereby facilitating switching of the support 300 from the first position to the second position.

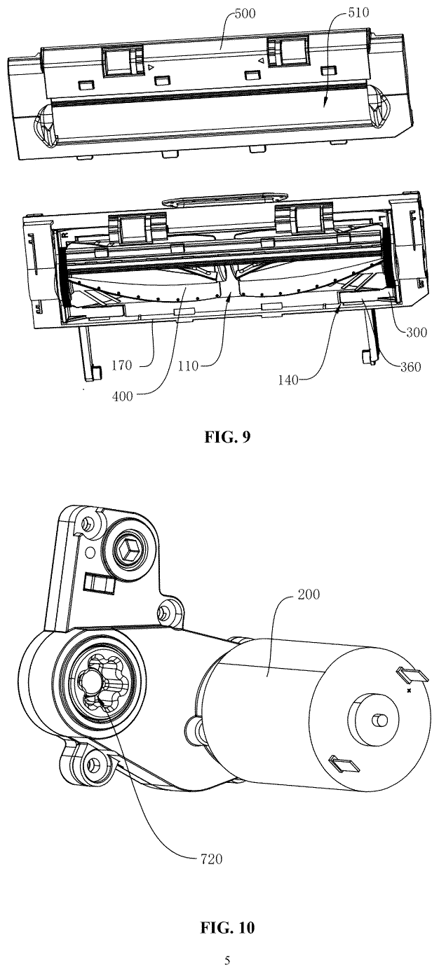

In some embodiments, referring to FIG. 9, the cleaning apparatus further includes a cover body 500 covering at least part of the positioning groove 140. The cover body 500 covers the positioning groove 140 to restrict the positioning part 360 inside the positioning groove 140, so that the support 300 is kept at the first position, thereby ensuring the normal operation of the cleaning member 400. The cover body 500 may completely or partially cover the positioning groove 140 as long as the cover body 500 can restrict the positioning part 360 from sliding out of the positioning groove 140. Before a cleaning member 400 is detached, the cover body 500 may be separated from the positioning groove 140, the positioning part 360 slides out of the positioning groove 140, and the support 300 rotates, so that the cleaning member 400 can be detached from the support 300.

In some embodiments, referring to FIG. 9, an extending part 170 is disposed at an edge of the accommodating groove 110, and the cover body 500 covers the accommodating groove 110 and is connected to the extending part 170 so complete the connection between the cover body 500 and the housing 100. The cover body 500 is generally provided with a working window 510, and a part of the cleaning member 400 extends from the working window 510 for performing a cleaning operation. In order to facilitate manufacturing, the extending part 170 is an extending plate.

In some embodiments, referring to FIG. 10 and FIG. 11, the cleaning apparatus further includes a supporting member 600. The driving member 200 is provided with an embedding groove 721; a matching hole 411 is provided in the cleaning member 400; and one end of the supporting member 600 penetrates through the matching hole 411 and the other end of the supporting member 600 is detachably connected into the embedding groove 721. A rotating head 630 may be disposed on the supporting member 600, and the shape of the rotating head 630 may match the shape of the embedding groove 721, so that the firmness of the connection between the driving member 200 and the supporting member 600 is improved. A plurality of protrusions may be disposed on a circumference of the rotating head 630 and a plurality of depressions may be disposed on an inner wall of the embedding groove 721. When the rotating head 630 is embedded in the embedding groove 721, the protrusions are located in the depressions, thereby preventing relative rotation between the rotating head 630 and the driving member 200. In a installation state, the rotating head 630 may be in clearance fit with the embedding groove 721, thereby facilitating detachment as long as the embedding groove 721 can drive the rotating head 630 to rotate. The rotating head 630 and the supporting member 600 may be connected through threads, or may be integrally formed. The supporting member 600 supports the cleaning member(s) 400, and meanwhile, the connection between the cleaning member(s) 400 and the driving member 200 may be achieved through the supporting member 600, so that the cleaning member(s) 400 rotates relative to the housing 100 under the driving of the driving member 200.

It may be understood that when a cleaning member 400 is at the first position, the rotating head 630 is located in the embedding groove 721, so that the cleaning member 400 is connected to the driving mechanism and rotates relative to the housing 100 under the action of the driving mechanism to complete the cleaning operation. When the cleaning member 400 moves from the first position to the second position, the rotating head 630 pulls out of the embedding groove 721, so that the cleaning member 400 is separable from the driving mechanism when the cleaning member 400 is at the second position, thereby facilitating removing the cleaning member 400 for replacement or cleaning.

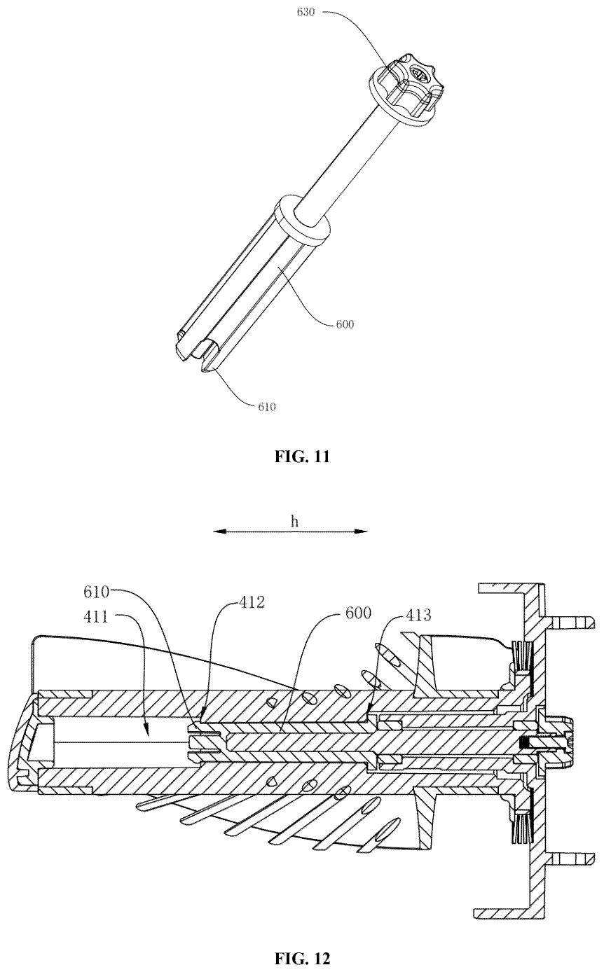

In some embodiments, referring to FIG. 12, the size of the supporting member 600 in a length direction of a cleaning member 400 (such as the direction h in FIG. 12) is greater than or equal to half of the length of the cleaning member 400, which can provide a larger support range for the cleaning member 400, reduce the deflection and deformation of the cleaning member 400, and thus improve the stability and the carrying capacity of the cleaning apparatus.

In some embodiments, when “two opposite sides of the matching protrusion 410 form a first matching surface 412 and a second matching surface 413”, the first matching surface 412 is located at an end of the matching protrusion 410 away from the driving member 200, a stop member 610 is disposed at an end of the supporting member 600 away from the driving member 200, and a first stop surface 611 that fits the first matching surface 412 is formed on the stop member 610. The first matching surface 412 fits the first stop surface 611 to restrict the sliding of the supporting member 600 inside the matching hole 411 and prevent the cleaning member 400 from detaching from the supporting member 600 during rotation. The first matching surface 412 may be an arc-shaped surface or an inclined plane, and the embodiments of the present disclosure do not specially restrict the specific shape of the first matching surface 412.

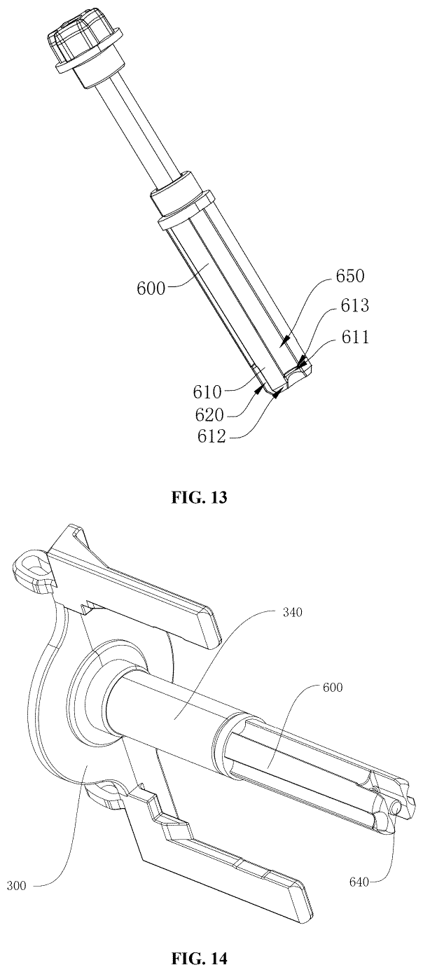

Referring to FIG. 13, in some embodiments, the first stop surface 611 is provided with a detachment guide surface 613, and the detachment guide surface 613 is configured to cooperatively slide relative to the first matching surface 412 when the cleaning member 400 is detached. Through the relative sliding between the assembling guide surface 612 and the matching hole 411, the first matching surface 412 fits the first stop surface 611, so that the supporting member 600 is smoothly assembled into the matching hole 411. The assembling guide surface 612 may be an arc-shaped surface or an inclined surface, and the embodiments of the present disclosure do not specially limit the specific shape of the assembling guide surface 612.

Referring to FIG. 12 to FIG. 14, in some embodiments, when “two opposite sides of the matching protrusion 410 form a first matching surface 412 and a second matching surface 413”, the second matching surface 413 is disposed at an end of the matching protrusion 410 close to the driving member 200, and a second stop surface that fits the second matching surface 413 is formed on the supporting member 600. The second matching surface 413 fits the second stop surface to restrict the sliding of the supporting member 600 in the matching hole 411. During installation, the supporting member 600 extends into an assembly hole until the second matching surface 413 fits the second stop surface. Through the fitting of the second matching surface 413 and the second stop surface, the installation position of the supporting member 600 in the assembly hole can be quickly determined, thereby improving the assembly efficiency. The distance between the first matching surface 412 and the second matching surface 413 is equal to the distance between the first stop surface 611 and the second stop surface, so that the stability of the connection between the supporting member 600 and the cleaning member 400 is improved.

Referring to FIG. 12 to FIG. 14, in some embodiments, the stop member 610 is provided with an assembling guide surface 612, and the smallest angle between the assembling guide surface 612 and the axial direction of the cleaning member 400 is an acute angle.

Referring to FIG. 12 to FIG. 14, in some embodiments, a rebound space 620 for the stop member 610 is formed on the supporting member 600. When a force is applied, the detachment guide surface 613 and the first matching surface 412 slide relatively, and the stop member 610 retracts to the rebound space 620, so that the supporting member 600 can be smoothly taken out from the matching hole 411.

Referring to FIG. 12 to FIG. 14, in some embodiments, the minimum distance between an inner wall of the rebound space 620 and the driving member 200 is less than the distance between the first matching surface 412 and the driving member 200, so that one end of the stop member 610 away from the driving member 200 is suspended, and the stop member 610 is elastic. Thus, it is convenient for the stop member 610 to retract to the rebound space 620 after a force is applied.

Referring to FIG. 12 to FIG. 15, in some embodiments, the supporting member 600 is provided with a limiting part 640, and the limiting part 640 is disposed among a plurality of stop members 610, and gaps are formed between the limiting part 640 and the stop members 610. The stop member 610 retracts to the rebound space 620 until the stop member 610 is abutted against the limiting part 640, the degree of retraction of the stop member 610 can be restricted through the limiting part 640, thereby preventing the stop member 610 from being broken due to excessive bending.

In some embodiments, the stop member 610 is at least partially elastic, so that it is convenient for the stop member 610 located in the rebound space 620 to return to its original position. The stop member 610 may be completely or partially elastic, which is not specially limited by the embodiments of the present disclosure.

In some embodiments, referring to FIG. 13 and FIG. 14, at least two stop members 610 are disposed, and the stop members 610 are distributed in a circumferential direction of the supporting member 600, so that it is convenient for the stop members 610 to cooperate with the matching hole 411.

In some embodiments, referring to FIG. 13 and FIG. 14, two stop members 610 are disposed and a rebound space 620 is formed between the stop members 610 on two opposite sides. During installation or detachment of the cleaning member 400, the stop members 610 are bent to the opposite side by force, and the rebound space 620 is located between the two stop members 610 on two opposite sides, so that the stop members 610 can retract into the rebound space 620. Thus, the cleaning member 400 can be smoothly installed or detached. In addition, the rebound space 620 is disposed between the stop members 610 on two opposite sides so as to maximize the volume of the rebound space 620, so that the stop members 610 move more flexibly.

In some embodiments, referring to FIG. 13 and FIG. 14, the stop member 610 is provided with a sliding groove 650, and the sliding groove 650 may be in slide fit with the matching protrusion 410. Through the slide fit between the sliding groove 650 and the matching protrusion 410, the cleaning member 400 and the supporting member 600 cooperate with each other more smoothly.

In some embodiments, referring to FIG. 13 and FIG. 14, inner walls of the sliding groove 650 and the matching protrusion 410 in the axial direction of the cleaning member 400 are arc-shaped, so that the resistance of sliding between the sliding groove 650 and the matching protrusion 410 can be reduced, thereby improving the detachment and assembly efficiency.

In some embodiments, referring to FIG. 14, the support 300 is provided with a connecting part 340; and the connecting part 340 sleeves outside of the supporting member 600. Through the supporting member 600, the cleaning member 400 may be installed on the support 300; and the connecting part 340 sleeves outside of the supporting member 600 to support the supporting member 600, so that the supporting member 600 is kept stable in the working state. The supporting member 600 is rotatable relative to the connecting part 340, to avoid the support 300 from rotating with the rotation of the supporting member 600. To achieve the relative rotation between the supporting member 600 and the support 300, a bearing can installed between the supporting member 600 and the support 300, so that the supporting member 600 is rotatable smoothly relative to the support 300. The connecting part 340 may be connected to the base 310.

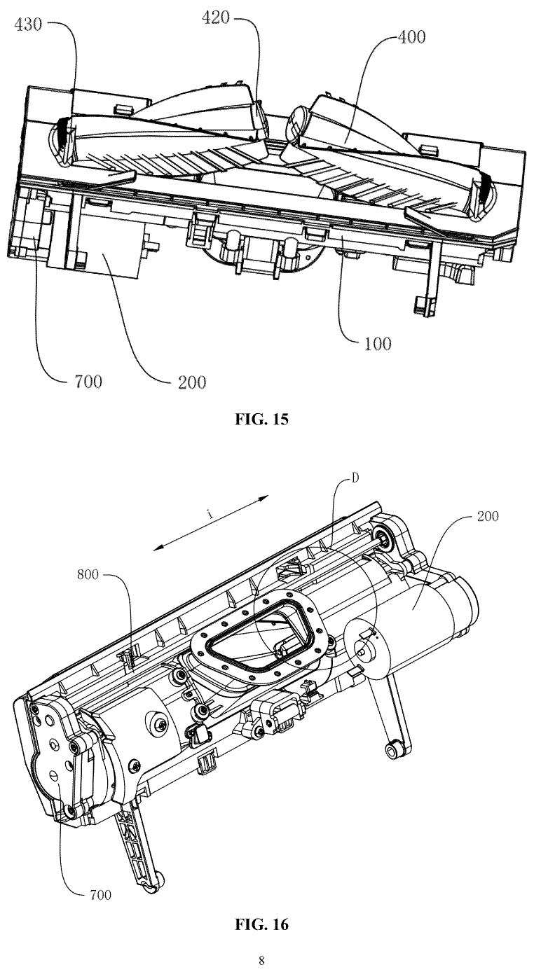

Referring to FIG. 15, a cleaning member 400 is provided with a free end 420 and a fixed end 430, and the fixed end 430 is detachably connected to the driving member 200. During the detachment of the cleaning member 400, only the fixed end 430 of the cleaning member 400 needs to be detached, so that the workload of detachment can be reduced while ensuring the normal operation of the cleaning member 400. The driving member 200 is disposed on the housing 100. The driving member 200 is fixed through the housing 100 to ensure the stability of the driving member 200 during operation. The fixed end 430 of the cleaning member 400 is detachably connected to the driving member 200, and the driving member 200 supports and drives the cleaning member 400.

The fixed end 430 of the cleaning member 400 is detachably connected to the driving member 200; and when the cleaning member 400 is in a working state, the driving member 200 may drive the cleaning member 400 to rotate relative to the housing 100 through the fixed end 430. When the cleaning member 400 is in the detached state, the fixed end 430 is directly separated from the driving member 200, so that the operation during detachment is reduced. Since the free end 420 of the cleaning member 400 is suspended, the free end 420 of the cleaning member 400 has more operation space, so that the housing 100 or other parts can be avoided during detachment.

In the embodiments of the present disclosure, one driving member 200 drives a plurality of cleaning members 400 to work, so that the situation that a driving member 200 is individually configured for each cleaning member 400 is avoided, thereby reducing the device procurement cost. The maintenance of a single driving member 200 usually requires less spare parts and shorter maintenance time than maintenance of a plurality of driving members 200, so that it is more economical to provide the single driving member 200. The plurality of cleaning members 400 is operated and controlled with one driving member 200, which is conducive to fault diagnosis of the cleaning apparatus, thereby facilitating timely detection and handling of problems. In addition, single driving member 200 is used to drive the plurality of cleaning members 400, which can reduce energy loss, improve overall energy efficiency, optimize energy utilization, and reduce energy consumption.

During the operation of the cleaning apparatus, the plurality of cleaning members 400 usually perform motions synchronously. Therefore, with a smaller number of driving members 200, it can be ensured that all cleaning members 400 operate synchronously, so that the operation efficiency of the cleaning apparatus is improved. The use of one driving member 200 is also more conducive to the centralized control and monitoring of the plurality of cleaning members 400, thereby increasing the automation degree and response speed of the cleaning apparatus.

Referring to FIG. 15, in the embodiments of the present disclosure, at least one transmission member 700 is further included, and the transmission member 700 is correspondingly connected to a cleaning member 400, and the transmission member 700 drives a corresponding cleaning member 400 to perform a motion under the driving of the driving member 200.

The power generated by the driving member 200 can be transmitted to each cleaning member 400 through the transmission member 700, so that each cleaning member 400 rotates relative to the housing 100. Thus, a small number of driving members drive a larger number of cleaning members 400 to operate. A plurality of gears or belt pulleys of different diameters may be used as the transmission member 700 to achieve the adjustment of the rotation speed and the effect of adjusting the speed. Different transmission members 700 can use different transmission ratios, so that the plurality of cleaning members 400 are rotatable at different speeds.

Referring to FIG. 16, in the embodiments of the present disclosure, a linkage member 800 is further included. The linkage member 800 is connected to at least two transmission members 700. The synchronous motions of a plurality of transmission members 700 can be achieved since the linkage member 800 is connected to the at least two transmission members 700. An output shaft of the driving member 200 is connected to the linkage member 800. The plurality of transmission members 700 can be driven synchronously by driving the linkage member 800. As the linkage member 800 is connected to the plurality of transmission members 700, the driving member 200 can drive the plurality of transmission members 700 to rotate as long as the driving member 200 is connected to the linkage member 800, and the driving member 200 does not need to be directly connected to the plurality of transmission members 700. Thus, an installation position of the driving member 200 is more flexible, which is conducive to the overall layout of the cleaning apparatus, and makes the structure of the cleaning apparatus more compact. The linkage member 800 may be a rod, and the plurality of transmission members 700 may be distributed in a length direction of the linkage member 800 (such as the direction i in FIG. 16), and the rod-shaped linkage member 800 can save space.

In other embodiments, the output shaft of the driving member 200 may be connected to at least one transmission member 700, the driving member 200 can drive one of the transmission members 700, and then another transmission member 700 is driven to perform a motion through the linkage member 800, realizing an effect that one driving mechanism is capable of driving the plurality of transmission members 700 to perform motions. Thus, the single driving member drives the plurality of cleaning members 400 to rotate relative to the housing 100. The output shaft of the driving member 200 may be connected to one, two, three, or four transmission members 700 to ensure the rotation stability of the cleaning member 400, which is not limited in the embodiments of the present disclosure.

In other embodiments, the output shaft of the driving member 200 may be connected to the linkage member 800 and the at least one transmission member 700 to improve the stability of power transmission and ensure the stable rotation of the cleaning member 400. Generally, the driving member 200 is a motor.

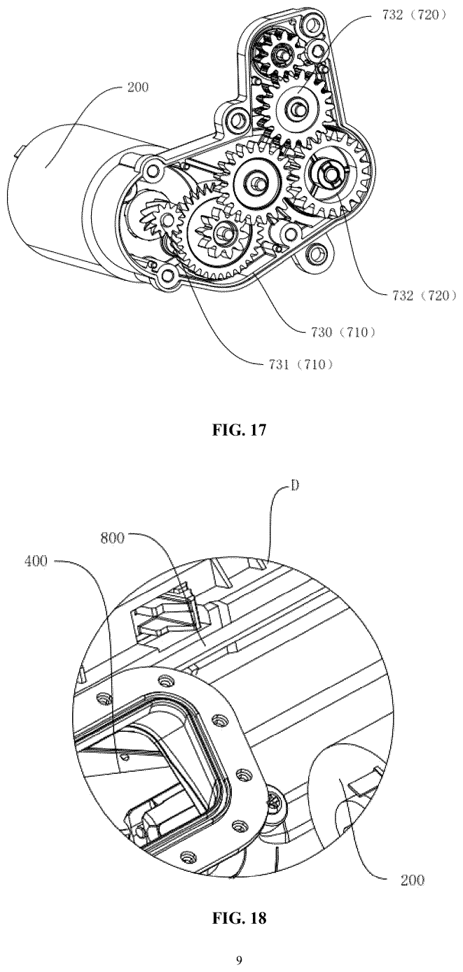

In some embodiments, referring to FIG. 17, a transmission member 700 includes an input wheel 710 and an output wheel 720. The output wheel 720 is connected to the output shaft of the driving mechanism, and the input wheel 710 is coupled to the output wheel 720. The driving member 200 drives the output wheel 720 to rotate through the coupling of the output wheel 720 and the input wheel 710.

In some embodiments, referring to FIG. 17 and FIG. 18, the transmission member 700 includes a first transmission member 730. The first transmission member 730 includes a first input wheel 731 and two first output wheels 732. The first input wheel 731 is connected to the driving shaft of the driving member 200, and one of the first output wheels 732 is connected to the corresponding cleaning member 400, and the other first output wheel 732 is connected to the linkage member 800. As the driving shaft of the driving member 200 is connected to the first output wheel 732, the connection of the first transmission member 730 and the driving member 200 is achieved, and then the linkage member 800 and the cleaning member 400 corresponding to the first transmission member 730 are driven to rotate through the first transmission member 730. The first input wheel 731 is coupled to one of the first output wheels 732, one of the first output wheels 732 is coupled to the other first output wheel 732, and the first input wheel 731 may drive the corresponding cleaning member 400 to rotate. Meanwhile, the first input wheel 731 may also drive other cleaning members 400 to rotate through the linkage member 800, so that the plurality of cleaning members 400 rotate relative to the housing 100. In other embodiments, the first input wheel 731 may also be coupled to the two first output wheels 732 to drive the two first output wheels 732 to rotate.

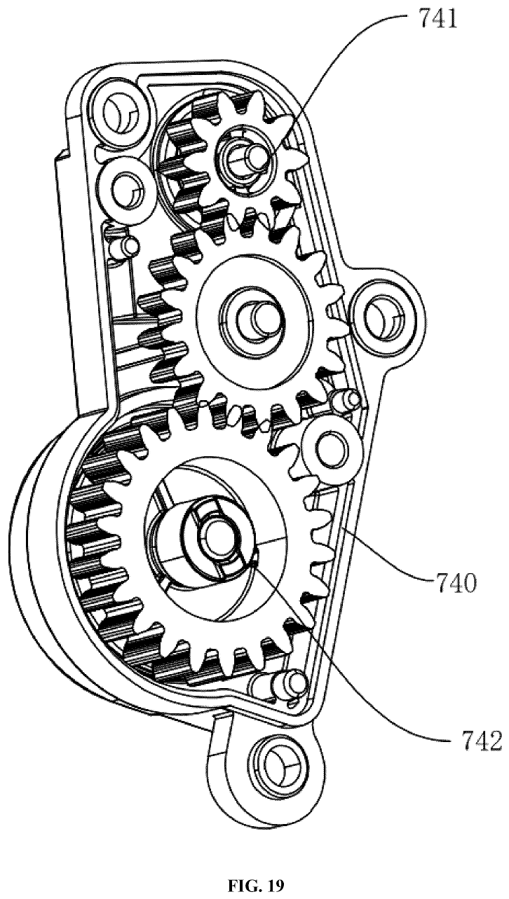

Referring to FIG. 18 and FIG. 19, the transmission member 700 may further include a second transmission member 740. The second transmission member 740 includes a second input wheel 741 and a second output wheel 742. The second input wheel 741 is connected to the linkage member 800, the second output wheel 742 is connected to a corresponding cleaning member 400, and the second input wheel 741 is coupled to the second output wheel 742. The corresponding cleaning member 400 rotates through the coupling of the second output wheel 742 and the second input wheel 741.

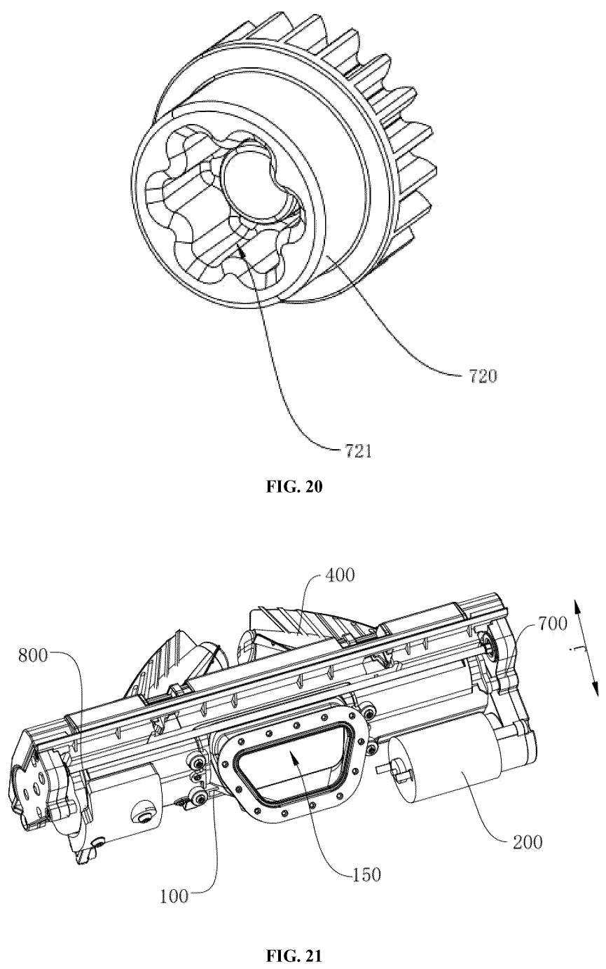

Referring to FIG. 20, the output wheel 720 may be provided with an embedding groove 721, so that the output wheel 720 drives a corresponding cleaning member 400 to rotate.

In some embodiments, the output wheels 720 connected to the different cleaning members 400 have the same rotating speed, so that the cleaning members 400 can rotate synchronously, which is conducive to cooperation among the cleaning members 400 to transfer sundries to a space between the cleaning members 400.

In some embodiments, referring to FIG. 21, two transmission members 700 are provided, and the two transmission members 700 are disposed on two opposite sides of the housing 100; one end of the linkage member 800 is connected to one transmission member 700 and the other end of the linkage member 800 is connected to the other transmission member 700. The transmission members 700 are disposed on two opposite sides of the housing 100, so that the energy loss can be reduced when the linkage member 800 transmits power, and meanwhile this is conducive to ensuring synchronous motion of the transmission members 700 on two sides of the housing 100 through the linkage member 800. The transmission members 700 on two opposite sides of the housing 100 are connected through the linkage member 800, so that the force and torque can be distributed more evenly in the whole cleaning apparatus, which is conducive to reducing stress concentration and prolonging the service life of the transmission members 700 and the linkage member 800. The transmission members 700 are located on two opposite sides of the housing 100, which reduces the risk of vibration and imbalance that may be caused by the transmission member 700 located on a single side. Thus, the whole cleaning apparatus operates more stably and reliably.

In some embodiments, referring to FIG. 21, the output shaft of the driving member 200 is disposed along a direction of a rotating axis of the cleaning member 400. Because the driving member 200 is generally strip-shaped and its length direction is an extending direction of the output shaft of the driving member 200, the output shaft of the driving member 200 is disposed along the direction of the rotating axis of the cleaning member 400 to reduce the vertical size of the driving member 200 (such as the direction j in FIG. 21), and thus reduce the vertical size of the cleaning apparatus. This is conducive to the miniaturization and flattening of the cleaning apparatus. The rotating axis of the cleaning member 400 is the rotating axis of the cleaning member 400 in the working state; and the vertical direction is the height direction of the cleaning apparatus in the working state.

In some embodiments, referring to FIG. 21, the plurality of transmission members 700 are disposed at ends of the housing 100 respectively, so that the space inside the cleaning apparatus may be used more efficiently and the structure of the cleaning apparatus is more compact, which is conducive to the miniaturization of the cleaning apparatus. The transmission members 700 are disposed at the ends of the housing 100, so that the installation, maintenance and repair of the transmission members 700 are more convenient, and a maintenance worker can inspect the transmission members 700 more quickly.

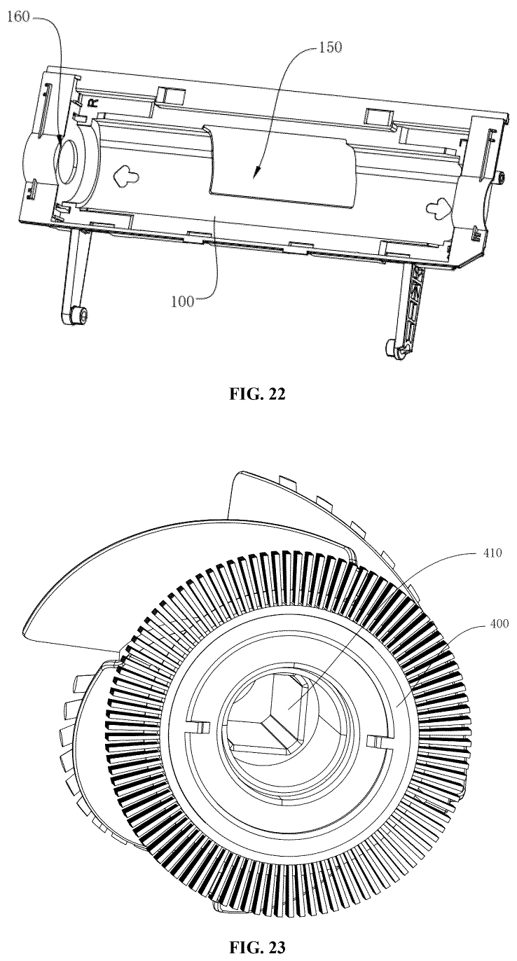

In some embodiments, referring to FIG. 22, installation grooves 160 for the transmission members 700 are formed at the ends of the housing 100. The installation grooves 160 can have positioning and alignment functions for the transmission members 700, so that it is ensured that the transmission members 700 are correctly installed on the housing 100, and thus the embodiments can avoid looseness or falling off of the transmission members 700.

In some embodiments, an extending direction from the fixed end 430 of a cleaning member 400 to a free end 420 of the cleaning member 400 points to another cleaning member 400, so that a gap is formed between the free ends 420 of two adjacent cleaning members 400, which is conducive to the detachment and assembly of the cleaning member 400, and facilitates passage of dust through the two cleaning members 400. As the extending direction from the fixed end 430 of one cleaning member 400 to the free end 420 of the cleaning member 400 points to another cleaning member 400, the size of the cleaning apparatus in the axial direction of the cleaning member 400 can be increased, thereby improving the cleaning efficiency. Meanwhile, the length of a single cleaning member 400 can be reduced, so that the shaking of the cleaning member 400 during operation can be reduced.

In some embodiments, referring to FIG. 22, the housing 100 is provided with a dust collection opening 150, and dust swept by a cleaning member 400 may be collected by the dust collection opening 150. A region between two cleaning members 400 overlaps with at least part of the dust collection opening 150 in axial directions of the cleaning members 400, so that the shielding of the dust collection opening 150 by the cleaning members 400 to can be reduced and the swept dust can smoothly enter the dust collection opening 150. The region between the two cleaning members 400 may completely or partially overlap with the dust collection opening 150. The dust collection opening 150 may be communicated to a dust collection component, the dust collection component may collect impurities such as dust, and may be a dust collection bag or a dust collection box. A dust suction component, such as a fan may be disposed on the dust collection component and may provide power for the flow of dust and other impurities.

In some embodiments, a guide plate (not shown in the figure) is disposed on the housing 100 and is suitable for directing an impurity to the dust collection opening 150. The guide plate plays the role of directing and may direct the impurity to the dust collection opening 150.

Embodiments of the present disclosure provide a cleaning system. The cleaning system includes a base station and the cleaning apparatus described above.

It may be understood that that if the cleaning apparatus has the beneficial effects in the above embodiments, the cleaning system correspondingly has the beneficial effects in the above embodiments, and for specific implementations of the cleaning system, reference may be made to the above embodiments, and repeated descriptions will be omitted here.

Since the cleaning apparatuses usually perform cleaning operations through the rotation of cleaning members, during the operation of the cleaning members, impurities such as hair are prone to wrap the cleaning members, and thus it is difficult to clean or replace the cleaning members. For example, the cleaning apparatuses, such as sweeping robots, usually clean the floor with cleaning brushes, and after cleaning for a period of time, it is easy for hair to wrap the cleaning brushes or dirt to adhere to the cleaning brushes and thus the cleaning brushes need to be removed for cleaning or replacement. However, in order to ensure the normal operation of the cleaning brushes, in the related art, the cleaning brushes are closely connected to the driving system(s) of the sweeping robots. As a result, it is difficult to detach the cleaning brushes.

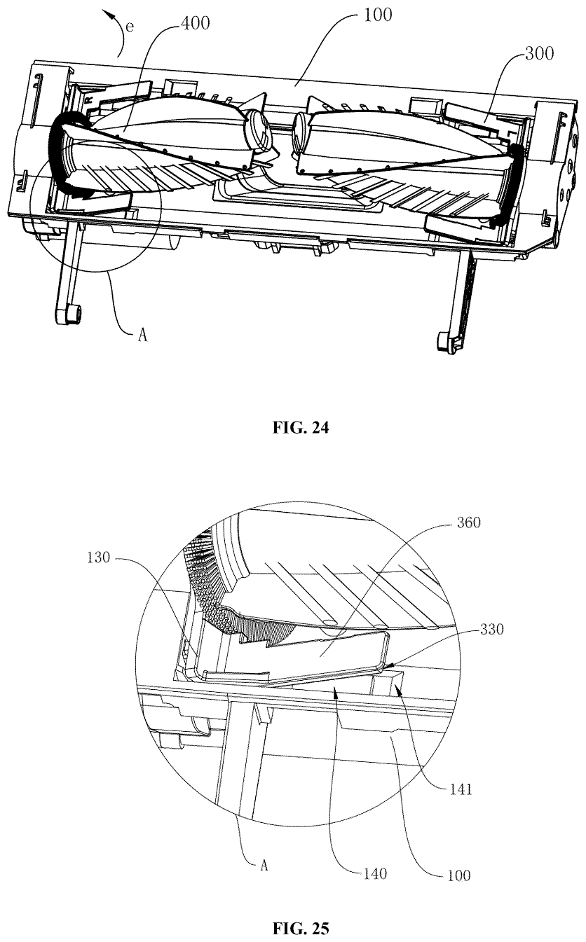

Embodiment of the present disclosure provide a cleaning apparatus. Referring to FIG. 24 to FIG. 26, the cleaning apparatus includes a housing 100, a driving member 200, a support 300 and a cleaning member 400. The driving member 200 is disposed on the housing 100, the cleaning member 400 rotates relative to the housing 100 under the action of the driving member 200, and the cleaning member 400 is installed on the support 300. The support 300 is rotatable between first and second positions. When the support 300 is at the first position, the cleaning member 400 is connected to a driving shaft of the driving member 200; and when the support 300 rotates to the second position, the cleaning member 400 is separated from the driving shaft of the driving member 200; and when the support 300 is at the second position, the cleaning member 400 is separable from the support 300.

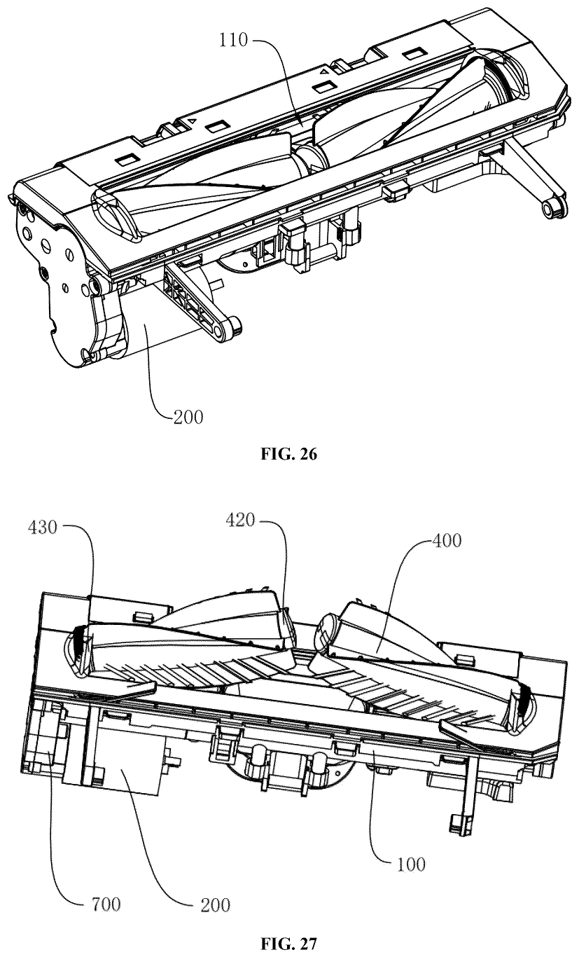

The support 300 is rotatable relative to the housing 100. By switching the support 300 between the first position and the second position, the cleaning member 400 switches between a working state and a detachment state. The cleaning member 400 is connected to the driving shaft of the driving member 200 when the support 300 is at the first position, so that the cleaning member 400 rotates relative to the housing 100 under the action of the driving member 200 to complete the cleaning operation. The cleaning member 400 is separable from the support 300 when the support 300 is at the second position, so that it is convenient to take down the cleaning member 400 for replacement or cleaning. When the support 300 rotates to the second position, since the cleaning member 400 is separated from the driving shaft of the driving member 200, the situation that an operator is accidentally injured because the cleaning member 400 rotates when the cleaning member 400 is detached can be prevented, thereby improving the safety performance. FIG. 24 is a stereoscopic structural schematic diagram of the cleaning apparatus when the support 300 is at the second position, and FIG. 26 is a stereoscopic structural schematic diagram of the cleaning apparatus when the support 300 is at the first position.

In the embodiments of the present disclosure, the cleaning member 400 quickly switches between the working state and the detachment state through the rotation of the support 300. By installing the cleaning member 400 on the support 300, the cleaning member 400 can be moved outside an installation position through simple rotation of the support 300, so that the detachment operation of the cleaning member 400 does not need to be limited to a narrow installation position. The installation position of the cleaning member 400 is a position where the cleaning member 400 is located when the cleaning member 400 rotates relative to the housing 100 under the action of the driving member 200.

The cleaning member 400 is separated from the driving shaft of the driving member 200 when the support 300 rotates to the second position; that is, when the cleaning member 400 enters the detachment state, the cleaning member 400 is disengaged from the driving shaft of the driving member 200, thereby preventing the situation that the cleaning member 400 rotates relative to the housing 100 when the cleaning member 400 is in the detachment state, and reducing the risk of accidentally injuring the operator because the cleaning member 400 rotates when the cleaning member 400 is detached. Through the rotation of the support 300, the cleaning member 400 switches between the working state and the detachment state and meanwhile the cleaning member 400 is quickly connected to or separated from the driving member 200, so that the safety of operation is improved.

The cleaning member 400 is separable from the support 300 when the support 300 is at the second position, and at this time, the cleaning member 400 can be removed for replacement or cleaning. Similarly, when the support 300 is at the second position, the cleaned cleaning member 400 or a new cleaning member 400 may be installed on the support 300, and the installation of the cleaning member 400 can be completed by rotating the support 300.

The driving member 200 is disposed on the housing 100, and the cleaning member 400 rotates relative to the housing 100 under the action of the driving member 200. Shaking of the cleaning member 400 during working is reduced by fixing the driving member 200 through the housing 100.

The cleaning member 400 may be a cleaning brush, a rolling mopping cloth or the like.

In some embodiments, referring to FIG. 24 to FIG. 26, the housing is provided with an accommodating groove 110 for the cleaning member 400, and the support 300 rotates in a direction from the inside of the accommodating groove 110 to the outside of the accommodating groove 110 (such the direction e in FIG. 24). Through the rotation of the support 300, the cleaning member 400 moves from the inside of the accommodating groove 110 to the outside of the accommodating groove 110, so that the space limitation during detachment is reduced, thereby avoiding collision with an inner wall of the accommodating groove 110 or other parts inside the accommodating groove 110 when the cleaning member 400 is detachment, and reducing the difficulty in detachment. When the cleaning member 400 is in the working state, a part of the cleaning member 400 is located in the accommodating groove 110, that is the accommodating groove 110 is the installation position of the cleaning member 400. The accommodating groove 110 provides physical protection for the cleaning member 400, and meanwhile the accommodating groove 110 provides necessary mechanical support and firmness for the cleaning member 400, so that the cleaning member 400 can rotate at a proper position.

In some embodiments, one of the support 300 and the housing 100 is provided with a movable shaft 120, and the other one of the support 300 and the housing 100 is provided with a matching groove 321; and the movable shaft 120 moves inside the matching groove 321 so that the support 300 switches between the first position and the second position. For example, referring to FIG. 3 and FIG. 4, the housing 100 is provided with the movable shaft 120 and the support 300 is provided with the matching groove 321.

The movable shaft 120 moves inside the matching groove 321 to achieve relative displacement between the support 300 and the housing 100, so that the support 300 switches between the first position and the second position. During rotation of the support 300, the movable shaft 120 is limited to be located in the matching groove 321, that is, a cooperative relationship is always kept between the support 300 and the housing 100. The cleaning member 400 can be moved outside the installation position through rotation of the support 300, thereby facilitating the detachment of the cleaning member 400. When the support 300 is moved to the first position, the cleaning member 400 installed on the support 300 can be moved to the installation position, so that the detachment cleaning member 400 can be quickly and accurately installed to the installation position, thereby increasing the installation speed of the cleaning member 400.

Alternatively, in other embodiments, it may be the case that the support 300 is provided with the movable shaft 120 and the housing 100 is provided with the matching groove 321, and embodiments of the present disclosure do not impose specific limitations on this.

In some embodiments, referring to FIG. 5, the matching groove 321 extends along the direction of the rotating axis of the cleaning member 400 (for example, the direction f in FIG. 5), so that when the movable shaft 120 moves inside the matching groove 321, the cleaning member 400 on the support 300 can move close to or away from the driving member 200, in order to be connected to or separated from the driving shaft of the driving member 200. If the matching groove 321 is in the support 300, the matching groove 321 extending along the direction of the rotating axis of the cleaning member 400 means that: in a case where the support 300 is at the first position, the matching groove 321 extends along the direction of the rotating axis of the cleaning member 400.

In some embodiments, referring to FIG. 5, an end of the matching groove 321 is provided with an arc-shaped inner wall to fit an arc-shaped outer surface of the movable shaft 120, thus facilitating the support 300 to rotate around the movable shaft 120 that serves as a rotating center.

In some embodiments, referring to FIG. 5 and FIG. 6, an end of the matching groove 321 away from the cleaning member 400 is inclined towards a direction away from the housing 100 (for example, the direction g in FIG. 6), so that the end of the matching groove 321 away from the cleaning member 400 can match a rotating path of the support 300, making the rotating procedure of the support 300 more smooth.

In some embodiments, referring to FIG. 5 and FIG. 6, the support 300 includes a base 310 and a connecting lug 320. The connecting lug 320 is disposed on the base 310 in a protruding manner. The matching groove 321 is formed in the connecting lug 320. Therefore, during installation, a position of the matching groove 321 can be determined fast to accelerate an installation speed. In addition, compared with directly forming the matching groove 321, the connecting lug 320 is disposed on the base 310 in a protruding manner in this embodiment of the present disclosure, which ensures that the support 300 can avoid the housing 100 or another component installed on the housing when rotating. This makes rotation of the support 300 relatively flexible.

In some embodiments, referring to FIG. 6 and FIG. 7, a fixing groove 130 for the connecting lug 320 is formed in the housing 100, so that the connecting lug 320 can be limited in the fixing groove 130 to reduce shaking of the connecting lug 320 when the support 300 rotates. Therefore, rotating stability of the support 300 is improved. The movable shaft 120 penetrates through a side wall of the fixing groove 130. When the connecting lug 320 moves in the fixing groove 130, the movable shaft 120 moves within the matching groove 321, which realizes matching between the movable shaft 120 and the matching groove 321. For example, the fixing groove 130 is provided with a first side wall 131 and a second side wall 132 that are disposed oppositely. The connecting lug 320 is located between the first side wall 131 and the second side wall 132, while the rotating axis penetrates through the first side wall 131, the matching groove 321 and the second side wall 132 sequentially. When the connecting lug 320 moves between the first side wall 131 and the second side wall 132, a relative displacement occurs between the movable shaft 120 and the matching groove 321, thereby realizing switching of the support 300 between the first position and the second position. Two connecting lugs 320 may be disposed, to ensure rotating stability of the support 300. The number of the connecting lugs 320 is not particularly limited in embodiments of the present disclosure.

In some embodiments, referring to FIG. 25, the housing 100 is provided with a positioning groove 140; the support 300 is provided with a positioning part 360; and the positioning part 360 is at least partially located in the positioning groove 140 when the support 300 is at the first position. The positioning groove 140 limits movement of the positioning part 360, so that the support 300 is kept at the first position to ensure normal operation of the cleaning member 400. The positioning part 360 may be partially or completely located in the positioning groove 140, as long as the positioning groove 140 can limit movement of the positioning part 360. A shape of the positioning groove 140 may match the shape of the positioning part 360 to better fix the positioning part 360.

The positioning part 360 is connected onto the base 310. The positioning groove 140 may be communicated with the fixing groove 130, to facilitate manufacturing. Two positioning parts 360 are disposed, and the two positioning parts 360 can better fix the support 300.

In some embodiments, referring to FIG. 25, the positioning groove 140 is provided with a first guide surface 141; and the support 300 slides out of the positioning groove 140 through the first guide surface 141. Due to relative sliding between the first guide surface 141 and the positioning part 360, the difficulty for the support 300 to slide out of the positioning groove 140 can be reduced, which facilitates switching of the support 300 from the first position to the second position. The first guide surface 141 may be an arc surface or an inclined surface. A specific shape of the first guide surface 141 is not particularly limited in embodiments of the present disclosure. The first guide surface 141 is disposed at a side of the positioning groove 140 away from the rotating center of the support 300, that is, the first guide surface 141 is disposed at a side of the positioning groove 140 away from the matching groove 321.

In some embodiments, referring to FIG. 25, the positioning part 360 is provided with a second guide surface 330; and the support 300 slides out of the positioning groove 140 through the second guide surface 330. Due to relative sliding between the second guide surface 330 and the positioning groove 140, the difficulty for the support 300 to slide out of the positioning part 360 can be reduced, which facilitates switching of the support 300 from the first position to the second position. The second guide surface 330 may be an arc surface or an inclined surface. A specific shape of the second guide surface 330 is not particularly limited in embodiments of the present disclosure. The second guide surface 330 is disposed at a side of the positioning part 360 away from the rotating center of the support 300, that is, the second guide surface 330 is disposed a side of the positioning part 360 away from the movable shaft 120.

In some embodiments, referring to FIG. 25, the positioning groove 140 is provided with a first guide surface 141 and the positioning part 360 is provided with a second guide surface 330. Due to relative sliding between the first guide surface 141 and the second guide surface 330, the difficulty for the support 300 to slide out of the positioning groove 140 can be reduced, which facilitates switching of the support 300 from the first position to the second position.

In some embodiments, referring to FIG. 9, the cleaning apparatus further includes a cover body 500 covering at least part of the positioning groove 140. As the cover body 500 covers the positioning groove 140 to limit the positioning part 360 in the positioning groove 140, the support 300 is kept at the first position to ensure normal operation of the cleaning member 400. The cover body 500 may cover the positioning groove 140 completely or partially, as long as the cover body 500 can prevent the positioning part 360 from sliding out of the positioning groove 140. Before detaching the cleaning member 400, the cover body 500 may be separated from the positioning groove 140; then, the positioning part 360 slides out of the positioning groove 140; and the cleaning member 400 can be detached from the support 300 by rotating the support 300.

In some embodiments, referring to FIG. 9, an extending part 170 is disposed at an edge of the accommodating groove 110; and the cover body 500 covers the accommodating groove 110 and is connected to the extending part 170 to complete connection between the cover body 500 and the housing 100. Generally, a working window 510 is formed in the cover body 500; and a part of the cleaning member 400 extends out of the working window 510 to perform a cleaning operation. To facilitate machining, the extending part 170 is an extending plate.

In some embodiments, referring to FIG. 10 and FIG. 11, the cleaning apparatus further includes a supporting member 600; the driving member 200 is provided with an embedding groove 721; a matching hole 411 is provided in the cleaning member 400; and one end of the supporting member 600 penetrates through the matching hole 411 and the other end of the supporting member 600 is detachably connected into the embedding groove 721. A rotating head 630 may be disposed on the supporting member 600. A shape of the rotating head 630 may match the shape of the embedding groove 721 to improve firmness of connection between the driving member 200 and the supporting member 600. A plurality of protrusions may be disposed on a circumference of the rotating head 630. A plurality of recesses may be disposed on an inner wall of the embedding groove 721. When the rotating head 630 is embedded in the embedding groove 721, the protrusions are in the recesses to prevent the rotating head 630 from rotating relative to the driving member 200. The rotating head 630 and the supporting member 600 may be connected through threads, or may be integrally formed. The supporting member 600 supports the cleaning member 400. Moreover, due to the supporting member 600, connection between the cleaning member 400 and the driving member 200 can be implemented, so that the cleaning member 400 can rotate relative to the housing 100 under the driving of the driving member 200.

In some embodiments, referring to FIG. 12, a size of the supporting member 600 in a length direction of the cleaning member 400 (for example, the direction h in FIG. 12) is greater than or equal to half of the length of the cleaning member 400, so that a larger support range can be provided for the cleaning member 400 to reduce deflection and deformation of the cleaning member 400. Therefore, stability and carrying capacity of the cleaning apparatus are increased.

In some embodiments, referring to FIG. 12 and FIG. 13, a first matching surface 412 is provided inside the matching hole 411; a stop member 610 is provided on the supporting member 600; and a first stop surface 611 fitting the first matching surface 412 is formed on the stop member 610. The first matching surface 412 fits the first stop surface 611 to limit sliding of the supporting member 600 in the matching hole 411, thereby preventing the cleaning member 400 from detaching from the supporting member 600 in a rotating procedure. The first matching surface 412 may be an arc surface or an inclined surface, and embodiments of the present disclosure do not impose specific limitations on the specific shape of the first matching surface 412.

In some embodiments, referring to FIG. 12 and FIG. 13, an assembling guide surface 612 is formed on the stop member 610; and the first matching surface 412 fits the first stop surface 611 through the assembling guide surface 612. Due to relative sliding between the assembling guide surface 612 and the matching hole 411, the first matching surface 412 fits the first stop surface 611, so that the supporting member 600 can be installed into the matching hole 411 successfully. The assembling guide surface 612 may be an arc surface or an inclined surface, and embodiments of the present disclosure do not impose specific limitations on the specific shape of the assembling guide surface 612. The assembling guide surface 612 may be located at an end of the stop member 610.

In some embodiments, referring to FIG. 12 and FIG. 13, a second matching surface 413 is provided in the matching hole 411; and a second stop surface fitting the second matching surface 413 is formed on the supporting member 600. Due to fitting between the second matching surface 413 and the second stop surface, sliding of the supporting member 600 in the matching hole 411 is limited. When being installed, the supporting member 600 extends into an assembling hole until the second matching surface 413 fits the second stop surface. Due to fitting between the second matching surface 413 and the second stop surface, an installation position of the supporting member 600 in the assembling hole can be determined fast, thereby improving assembling efficiency.

In some embodiments, referring to FIG. 12 and FIG. 13, a first matching surface 412 may be disposed in the matching hole 411; and a first stop surface 611 fitting the first matching surface 412 is formed on the stop member 610. Moreover, a second matching surface 413 is provided in the matching hole 411; and a second stop surface fitting the second matching surface 413 is formed on the supporting member 600. Due to the first matching surface 412 and the second matching surface 413, the supporting member 600 is limited at a specific position in the matching hole 411. A matching protrusion 410 is provided on the cleaning member 400; the matching protrusion 410 is disposed in the matching hole 411; and the first matching surface 412 and the second matching surface 413 are formed on two opposite sides of the matching protrusion 410, to fix the supporting member 600. A distance between the first matching surface 412 and the second matching surface 413 is equal to a distance between the first stop surface 611 and the second stop surface, so that stability of connection between the supporting member 600 and the cleaning member 400 is improved.

In some embodiments, referring to FIG. 12 and FIG. 13, a detachment guide surface 613 is provided on a first stop surface 611. During detaching of the cleaning member 400, the detachment guide surface 613 and the first matching surface 412 slide relative to each other, so that the first matching surface 412 is separated from the first stop surface 611. Therefore, the supporting member 600 can be taken out of the matching hole 411 successfully. The detachment guide surface 613 may be an arc surface or an inclined surface, and embodiments of the present disclosure do not impose specific limitations on the specific shape of the detachment guide surface 613.

In some embodiments, referring to FIG. 12 and FIG. 13, a rebound space 620 for the stop member 610 is formed on the supporting member 600. When a force is applied, the detachment guide surface 613 and the first matching surface 412 slide relative to each other, and the stop member 610 retracts into the rebound space 620, so that the supporting member 600 can be taken out of the matching hole 411 successfully.

In some embodiments, referring to FIG. 12 and FIG. 13, at least two stop members 610 are disposed; and the stop members 610 are distributed in a circumferential direction of the supporting member 600 to facilitate matching between the stop member 610 and the matching hole 411. The rebound space 620 may be formed between the stop members 610 to increase volume of the rebound space 620 to the most extent, so that the stop members 610 can move more flexibly.

In some embodiments, the stop member 610 is at least partially elastic, so that the stop member 610 in the rebound space 620 can return to its original position conveniently. The stop member 610 may be completely or partially elastic, which is not particularly limited in embodiments of the present disclosure.

In some embodiments, referring to FIG. 14, a connecting part 340 is provided on the support 300; and the connecting part 340 sleeves outside of the supporting member 600. Due to the supporting member 600, the cleaning member 400 can be installed on the support 300. The connecting part 340 sleeves outside of the supporting member 600 to perform a function of supporting the supporting member 600, so that the supporting member 600 is kept stable in a working state. The supporting member 600 is rotatable relative to the connecting part 340, thereby preventing the support 300 from rotating with the rotation of the supporting member 600. To implement relative rotation between the supporting member 600 and the support 300, a bearing may be installed between the supporting member 600 and the support 300, so that the supporting member 600 can rotate smoothly relative to the support 300. The connecting part 340 may be connected onto the base 310.

Referring to FIG. 27, a cleaning member 400 is provided with a free end 420 and a fixed end 430; and the fixed end 430 is detachably connected to the driving member 200. To detach the cleaning member 400, only the fixed end 430 of the cleaning member 400 needs to be detached, which reduces the workload of detachment while normal operation of the cleaning member 400 is ensured. The driving member 200 is disposed in the housing 100, and is fixed by the housing 100 to ensure stability of the driving member 200 during operation. The fixed end 430 of the cleaning member 400 is detachably connected to the driving member 200. The driving member 200 performs functions of supporting and driving the cleaning member 400.

As the fixed end 430 of the cleaning member 400 is detachably connected to the driving member 200, when the cleaning member 400 is in a working state, the driving member 200 may drive, through the fixed end 430, the cleaning member 400 to rotate relative to the housing 100; and when the cleaning member 400 is in a detachment state, the fixed end 430 is detached from the driving member 200 directly, which reduces operations during detachment. The free end 420 of the cleaning member 400 is disposed in a suspended manner, so that there is a larger operation space at the position of the free end 420 of the cleaning member 400, which facilitates avoiding the housing 100 or other parts during detachment.

In some embodiments, referring to FIG. 27, at least two cleaning members 400 are disposed. Due to the plurality of cleaning members 400, an effective cleaning area can be enlarged, and a cleaning effect of the cleaning apparatus is improved. Each cleaning member 400 is provided with a fixed end 430 and a free end 420. The fixed end 430 of the cleaning member 400 is connected to the housing 100 through the support 300. To detach the cleaning member 400, only the fixed end 430 of the cleaning member 400 needs to be detached, which reduces workload of detachment. The free end 420 of one cleaning member 400 extends towards another cleaning member 400, which can reduce the influence on another cleaning member 400 when detaching one cleaning member 400, and help keep independence of each cleaning member 400.

The driving member 200 is in transmission connection with each cleaning member 400, and is configured to drive a plurality of cleaning members 400 to rotate relative to the housing 100. As one driving member 200 is used to drive a plurality of cleaning members 400 to rotate relative to the housing 100, the number of driving members 200 can be reduced, thereby reducing space occupied by the driving members 200. Therefore, layout of the cleaning apparatus is more compact to reduce a size of the cleaning apparatus to the most extent. One driving member 200 is used to drive a plurality of cleaning members 400, so that total weight of the driving members 200 can be reduced, which facilitates movement of the cleaning apparatus.

In this embodiment of the present disclosure, one driving member 200 is used to drive a plurality of cleaning members 400 to work, instead of configuring a driving member 200 separately for each cleaning member 400, so that device purchase costs are reduced. Generally, compared with maintaining a plurality of driving members 200, maintaining a single driving member 200 requires less spares and shorter maintenance time. Therefore, it is more economic to dispose a single driving member 200. Using one driving member 200 to drive and control a plurality of cleaning members 400 can also facilitate fault diagnosis of the cleaning apparatus, so that a fault can be found and treated in time. In addition, using a single driving member 200 to drive a plurality of cleaning members 400 can reduce energy loss, improve overall energy efficiency, optimize energy utilization, and reduce energy consumption.

In a working procedure of the cleaning apparatus, the plurality of cleaning members 400 usually perform a motion synchronously. Therefore, using one driving member 200 can ensure that all the cleaning member 400 operate synchronously, so that operating efficiency of the cleaning apparatus is improved. Using one driving member 200 also better facilitates implementation of centralized control and monitoring of the plurality of cleaning members 400, so that the automation degree and response speed of the cleaning apparatus are increased.

Referring to FIG. 27, in an embodiment of the present disclosure, a plurality of transmission members 700 may also be included. The transmission members 700 are connected to the cleaning members 400 correspondingly. Under the driving of the driving member 200, each transmission member 700 drives a corresponding cleaning member 400 to rotate.

Through the transmission members 700, power generated by the driving member 200 can be transferred to each cleaning member 400, causing each cleaning member 400 to rotate relative to the housing 100. Therefore, a plurality of cleaning members 400 can be driven to work by using one driving mechanism. The transmission members 700 may use a plurality of gears or belt pulleys having different diameters, so that rotating speed can be adjusted, and a speed adjusting effect is achieved. Different transmission members 700 may use different reduction gear ratios, so that the plurality of cleaning members 400 rotate at different speeds.

Referring to FIG. 16, in an embodiment of the present disclosure, a linkage member 800 is further included. The linkage member 800 is connected to at least two transmission members 700. As the linkage member 800 is connected to at least two transmission members 700, synchronous motion of a plurality of transmission members 700 can be realized. The output shaft of the driving member 200 is connected to the linkage member 800. The plurality of transmission members 700 can be driven synchronously by driving the linkage member 800. As the linkage member 800 is connected to the plurality of transmission members 700, the driving member 200 can drive the plurality of transmission members 700 to rotate only by its connection with the linkage member 800. The driving member 200 does not need to be directly connected to a plurality of transmission members 700, so that an installation position of the driving member 200 is more flexible, overall layout of the cleaning apparatus is facilitated, and a structure of the cleaning apparatus is more compact. The linkage member 800 may be a rod body. The plurality of transmission members 700 may be distributed in a length direction of the linkage member 800 (for example, the direction i in FIG. 16), so that the rod-shaped linkage member 800 can save space.

In other embodiments, the output shaft of the driving member 200 may be connected to at least one transmission member 700. The driving member 200 may drive one of the transmission members 700, and then drive another transmission member 700 to perform a motion through the linkage member 800, thereby achieving an effect that one driving mechanism drives a plurality of transmission members 700 to perform a motion, and achieving an effect that a single driving mechanism drives a plurality of cleaning members 400 to rotate relative to the housing 100. The output shaft of the driving member 200 may be connected to one, two, three, or four transmission members 700 to ensure rotating stability of the cleaning member 400, which is not limited in this embodiment of the present disclosure.

In other embodiments, the output shaft of the driving member 200 may be connected to the linkage member 800 and at least one transmission member 700, thereby improving power transferring stability and ensuring stable rotation of the cleaning member 400. Generally, the driving member 200 is a motor.

In some embodiments, referring to FIG. 17, the transmission member 700 includes an input wheel 710 and an output wheel 720; the output wheel 720 is connected to the output shaft of the driving member 200; and the input wheel 710 is coupled to the output wheel 720. As the output wheel 720 is coupled to the input wheel 710, the driving member 200 drives the output wheel 720 to rotate.

In some embodiments, referring to FIG. 17 and FIG. 18, the transmission member 700 includes a first transmission member 730; the first transmission member 730 includes a first input wheel 731 and two first output wheels 732; the first input wheel 731 is connected to the driving shaft of the driving member 200; one of the first output wheels 732 is connected to a corresponding cleaning member 400; and the other first output wheel 732 is connected to the linkage member 800. The driving shaft of the driving member 200 is connected to the first output wheels 732, so that the first transmission member 730 is connected to the driving member 200, and then, the first transmission member 730 drives the linkage member 800 and the cleaning member 400 corresponding to the first transmission member 730 to rotate. The first input wheel 731 is coupled to one of the first output wheels 732. One of the first output wheels 732 is coupled to the other first output wheel 732. The first input wheel 731 may drive a corresponding cleaning member 400 to rotate. Moreover, the first input wheel 731 may also drive another cleaning member 400 to rotate through the linkage member 800, so that a plurality of cleaning members 400 can rotate relative to the housing 100. In other embodiments, the first input wheel 731 may alternatively be coupled to the two first output wheels 732, thereby driving the two first output wheels 732 to rotate.

Referring to FIG. 18 and FIG. 19, the transmission member 700 may further include a second transmission member 740; the second transmission member 740 includes a second input wheel 741 and a second output wheel 742; the second input wheel 741 is connected to the linkage member 800; the second output wheel 742 is connected to a corresponding cleaning member 400; and the second input wheel 741 is coupled to the second output wheel 742. As the second output wheel 742 is coupled to the second input wheel 741, the corresponding cleaning member 400 can rotate.

Referring to FIG. 20, the embedding groove 721 may be formed in the output wheel 720, so that the output wheel 720 can drive a corresponding cleaning member 400 to rotate.

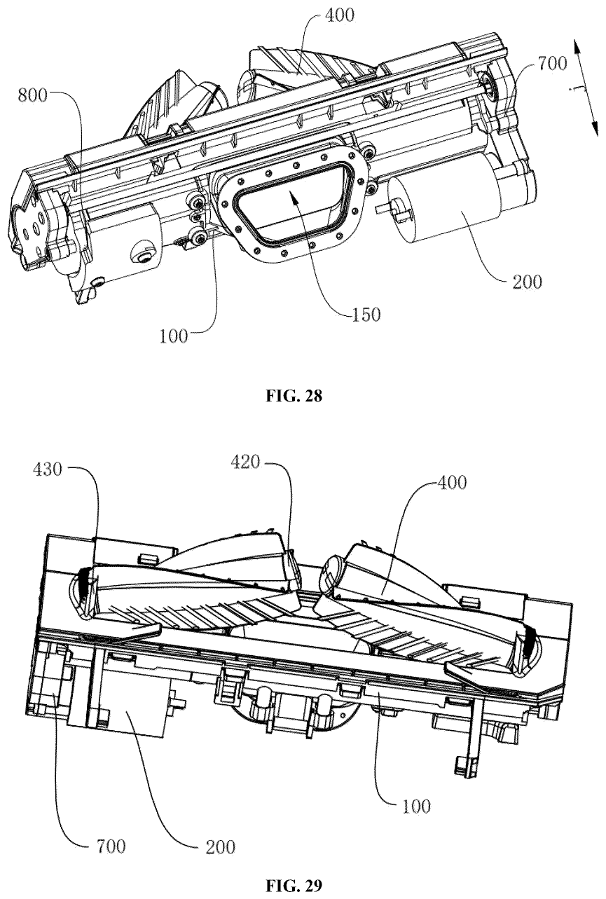

In some embodiments, referring to FIG. 28, two transmission members 700 are disposed on two opposite sides of the housing 100; and one end of the linkage member 800 is connected to one transmission member 700 and the other end of the linkage member 800 is connected to the other transmission member 700. As the transmission members 700 are disposed on two opposite sides of the housing 100, energy lost when the linkage member 800 transfers power can be reduced. Moreover, the linkage member 800 can better ensure synchronous motion of the transmission members 700 on the two sides of the housing 100. As the transmission members 700 on two opposite sides of the housing 100 are connected through the linkage member 800, power and torque can be distributed in the entire cleaning apparatus more uniformly, thereby reducing stress concentration, and prolonging service lives of the transmission members 700 and the linkage member 800. As the transmission members 700 are disposed on two opposite sides of the housing 100, risks of vibration and imbalance that may be caused by a transmission member 700 disposed on a single side are reduced, and the entire cleaning apparatus is enabled to run more smoothly and reliably.

In some embodiments, referring to FIG. 28, the output shaft of the driving member 200 is disposed along a direction of a rotating axis of the cleaning member 400. Because the driving member 200 is generally strip-shaped, and its length direction is an extending direction of the output shaft of the driving member 200, the output shaft of the driving member 200 is disposed along a direction of the rotating axis of the cleaning member 400 to reduce a size of the driving member 200 in a vertical direction (for example, the direction j in FIG. 28), thereby reducing a size of the cleaning apparatus in the vertical direction, and facilitating miniaturization and flattening of the cleaning apparatus. The rotating axis of the cleaning member 400 is a rotating axis of the cleaning member 400 in a working state. The vertical direction is a height direction of the cleaning apparatus in the working state.

In some embodiments, referring to FIG. 28, a plurality of transmission members 700 are separately disposed on at ends of the housing 100, so that inner space of the cleaning apparatus can be utilized more efficiently, thereby making a structure of the cleaning apparatus more compact, and facilitating miniaturization of the cleaning apparatus. As the transmission members 700 are disposed at the ends of the housing 100, the transmission members 700 can be installed, maintained, and overhauled more conveniently, and maintenance personnel can examine the transmission members 700 faster.

In some embodiments, referring to FIG. 22, installation grooves 160 for the transmission members 700 are formed at the ends of the housing 100. The installation grooves 160 can provide functions of positioning and aligning the transmission members 700, which ensures that the transmission members 700 can be installed on the housing 100 correctly, and are prevented from getting loose or falling off.

In some embodiments, referring to FIG. 22, the housing 100 is provided with a dust collection opening 150. After sweeping is performed, dust on the cleaning member 400 may be collected through the dust collection opening 150. The dust collection opening 150 is disposed between two cleaning members 400, which can reduce shielding of the dust collection opening 150 by the cleaning members 400. Therefore, dust can enter the dust collection opening 150 smoothly after sweeping. The dust collection opening 150 may be communicated with a dust collection component that may collect impurities such as dust. The dust collection component may be a dust collection bag or a dust collection box. The dust collection component may be provided with a dust suction component thereon, for example, a fan. The dust suction component may provide power for flowing of impurities such as dust.

In some embodiments, a guide plate (not shown in the figure) is disposed on the housing 100 and is suitable for directing impurities to the dust collection opening 150. The guide plate performs a directing function, and may guide impurities into the dust collection opening 150.

An embodiment of the present disclosure provides a cleaning device, including the foregoing cleaning apparatus.

It may be understood that the cleaning apparatus has beneficial effects of the foregoing embodiments. Correspondingly, the cleaning device has the beneficial effects of the foregoing embodiments. For specific implementations, reference may be made to the foregoing embodiments. Details are not described in this application again.

The cleaning device includes but is not limited to a sweeping robot, a ground mopping machine, or a washing and mopping integrated robot, and the like.

An embodiment of the present disclosure provides a cleaning system, including the foregoing cleaning apparatus or the foregoing cleaning device.

Generally, the cleaning apparatus performs cleaning operation via rotation of the cleaning member. However, in a working process of the cleaning member, impurities such as hair are easy to wind around the cleaning member. As a result, it is difficult to clean or replace the cleaning member. For example, in cleaning apparatuses such as a sweeping robot, a cleaning brush is generally used to clean a floor. After cleaning operation has been performed for a period of time, the cleaning brush is easy to be wound with hair or tainted with dirt, and the cleaning brush needs to be detached for cleaning or replacement. However, to ensure normal operation of the cleaning brush, in related art, a cleaning brush is tightly connected to a driving system of a sweeping robot. As a result, it is hard to detach the cleaning brush.

The present disclosure is described below with reference to the accompanying drawings and example embodiments.

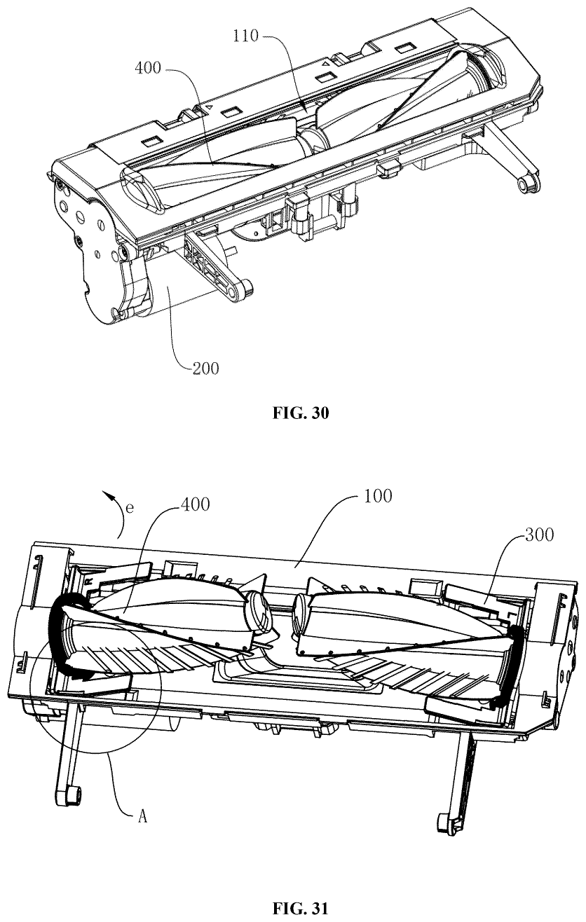

An embodiment of the present disclosure further provides a detachable cleaning member installed on the cleaning device. Referring to FIG. 29, FIG. 30, and FIG. 23, the cleaning member 400 includes a free end 420 and a fixed end 430; and the fixed end 430 is detachably connected to a driving mechanism. The cleaning member 400 is rotatable under the action of the driving mechanism. A matching hole 411 is provided in the cleaning member 400; at least one matching protrusion 410 is disposed in the matching hole 411; and the matching protrusion 410 is separably connected to the driving mechanism.

To detach the cleaning member 400 for washing and replacement, only the fixed end 430 of the cleaning member 400 needs to be detached, which reduces detaching workload and facilitates detaching on the premise that normal operation of the cleaning member 400 is ensured. The matching hole 411 is provided in the cleaning member 400, and the matching protrusion 410 is separably connected to the driving mechanism. Due to the matching protrusion 410, reliability of connection between the cleaning member 400 and the driving mechanism is improved, and detaching of the cleaning member 400 is facilitated.

The driving mechanism at least partially penetrates through the matching hole. During assembly, the driving part of the driving mechanism may penetrate through the matching hole 411, to ensure coaxiality of the cleaning member and the driving mechanism, and improve firmness of connection between the cleaning member 400 and the driving mechanism.

As the fixed end 430 of the cleaning member 400 is detachably connected to the driving mechanism, when the cleaning member 400 is in a working state, the driving mechanism may drive, through the fixed end 430, the cleaning member 400 to rotate relative to the housing 100; and when the cleaning member 400 is in a to-be-detached state, the fixed end 430 is detached from the driving mechanism directly, which reduces detaching operation. The free end 420 of the cleaning member 400 is disposed in a suspended manner, so that there is a larger operation space for the position of the free end 420 of the cleaning member 400, which facilitates avoiding the housing 100 or another part during detaching.

The cleaning member 400 may be a cleaning brush, a rolling mop or the like. The cleaning member 400 is detached independently, so that the cleaning member 400 can be washed independently, and components such as the driving mechanism do not need to be detached. Therefore, detaching workload is reduced.

In some embodiments, referring to FIG. 29, the cleaning member 400 is movable between the first position and the second position relative to the driving mechanism. When the cleaning member 400 is at the first position, the cleaning member 400 is connected to the driving mechanism. When the cleaning member 400 is at the second position, the cleaning member 400 may be detached from the driving mechanism.

By switching the cleaning member 400 between the first position and the second position, the cleaning member 400 switches between the working state and the to-be-detached state. When the cleaning member 400 is at the first position, the cleaning member 400 is connected to the driving mechanism, the cleaning member 400 rotates relative to the housing 100 under the action of the driving mechanism to complete cleaning operation. When the cleaning member 400 is at the second position, the cleaning member 400 may be detached from the driving mechanism, so that the cleaning member 400 can be taken off for replacement or cleaning, and an operator can be protected from being hurt accidentally by rotation of the cleaning member 400 during detaching of the cleaning member 400. Therefore, safety performance is improved.

In some embodiments, referring to FIG. 29, the cleaning member 400 is movable between the first position and the second position relative to the driving mechanism along an axial direction of the cleaning member 400.

With the movement of the cleaning member 400 in the axial direction, the cleaning member 400 switches between the working state and the to-be-detached state. The cleaning member 400 includes a free end 420 and a fixed end 430, so that there is more space provided at the position of the free end 420 of the cleaning member 400 for the cleaning member 400 to move axially, thereby switching between the working state and the to-be-detached state.

In some embodiments, referring to FIG. 23, at least two matching protrusions 410 are disposed. Due to the plurality of matching protrusions 410, the cleaning member 400 and the driving mechanism may match each other tightly, so that detachment of the cleaning member from the driving mechanism can be avoided in a working procedure. There may be one, two, three or four matching protrusions 410. The number of the matching protrusions 410 is not particularly limited in embodiments of the present disclosure.

In some embodiments, referring to FIG. 29, the matching protrusions 410 are disposed at the same position in an axial direction of the cleaning member 400. Positions where the matching protrusions 410 match the driving mechanisms may be unified. When the cleaning member 400 rotates, the matching protrusions 410 may still match the driving mechanism, so that flexibility of assembly between the cleaning member 400 and the driving mechanism is improved.

In some embodiments, referring to FIG. 12, in an axial direction of the cleaning member 400, two opposite sides of the matching protrusion 410 form a first matching surface 412 and a second matching surface 413 which are suitable for fixing the driving mechanism, so that the movement of the cleaning member 400 in the axial direction of the cleaning member 400 relative to the driving mechanism in a working procedure can be limited.

In some embodiments, referring to FIG. 12, at least one of the first matching surface 412 and the second matching surface 413 is perpendicular to an inner wall of the matching hole 411, which enhances connection between the matching protrusion 410 and the driving mechanism, further limits movement of the cleaning member 400 in the axial direction of the cleaning member 400 relative to the driving mechanism, and ensure normal operation of the cleaning member 400.

An embodiment of the present disclosure provides a cleaning apparatus, including a driving mechanism and the foregoing detachable cleaning member.

It may be understood that the detachable cleaning member has beneficial effects of the foregoing embodiments. Correspondingly, the cleaning apparatus has the beneficial effects of the foregoing embodiments. For specific implementations, reference may be made to the foregoing embodiments. Details are not described in this application again.

Referring to FIG. 31, the driving mechanism is disposed in the housing 100, and is fixed by the housing 100 to ensure stability of the driving mechanism during operation. The fixed end 430 of the cleaning member 400 is detachably connected to the driving mechanism. The driving mechanism performs functions of supporting and driving the cleaning member 400.

Referring to FIG. 29, in some embodiments, the driving mechanism includes a driving member 200 and a supporting member 600. The supporting member 600 is connected to a driving shaft of the driving member 200 and is disposed in the matching hole 411. The supporting member 600 provides a supporting force for the cleaning member 400. Through the supporting member 600, power of the driving member 200 can be transferred to the cleaning member 400, driving the cleaning member 400 to rotate relative to the housing 100.

In some embodiments, referring to FIG. 10 and FIG. 12, the driving member 200 is provided with an embedding groove 721. One end of the supporting member 600 penetrates through the matching hole 411 and the other end of the supporting member 600 is detachably connected into the embedding groove 721. A rotating head 630 may be disposed on the supporting member 600. A shape of the rotating head 630 may match a shape of the embedding groove 721 to improve firmness of connection between the driving member 200 and the supporting member 600. A plurality of protrusions may be disposed on a circumference of the rotating head 630. A plurality of recesses may be disposed on an inner wall of the embedding groove 721. When the rotating head 630 is embedded in the embedding groove 721, the protrusions are in the recesses to prevent the rotating head 630 from rotating relative to the driving member 200. In a installed state, the rotating head 630 may be in clearance fit with the embedding groove 721, as long as the embedding groove 721 can drive the rotating head 630 to rotate, so that it is convenient to detach the rotating head 630. The rotating head 630 and the supporting member 600 may be connected through threads, or may be integrally formed. The supporting member 600 performs a function of supporting the cleaning member 400. Moreover, due to the supporting member 600, connection between the cleaning member 400 and the driving member 200 can be realized, so that the cleaning member 400 can rotate relative to the housing 100 under the driving of the driving member 200.

It may be understood that when the cleaning member 400 is at the first position, the rotating head 630 is in the embedding groove 721, so that the cleaning member 400 is connected to the driving mechanism, and the cleaning member 400 rotates relative to the housing 100 under the action of the driving mechanism to complete cleaning operation. When the cleaning member 400 is moved from the first position to the second position, the rotating head 630 is withdrawn from the embedding groove 721, so that when the cleaning member 400 is at the second position, the cleaning member 400 may be detached from the driving mechanism to be taken off for replacement or cleaning.

In some embodiments, referring to FIG. 12, a size of the supporting member 600 in a length direction of the cleaning member 400 (for example, the direction h in FIG. 12) is greater than or equal to half of the length of the cleaning member 400, so that a larger support range can be provided for the cleaning member 400 to reduce deflection and deformation of the cleaning member 400. Therefore, stability and carrying capacity of the cleaning apparatus are increased.

In some embodiments, when “the first matching surface 412 and the second matching surface 413 are formed on two opposite sides of the matching protrusion 410”, the first matching surface 412 is disposed at an end of the matching protrusion 410 away from the driving member 200, a stop member 610 is disposed at an end of the supporting member 600 away from the driving member 200, and a first stop surface 611 that fits the first matching surface 412 is formed on the stop member 610. The first matching surface 412 fits the first stop surface 611 to limit sliding of the supporting member 600 in the matching hole 411, thereby preventing the cleaning member 400 from detaching from the supporting member 600 in a rotating procedure. The first matching surface 412 may be an arc surface or an inclined surface, and embodiments of the present disclosure do not impose specific limitations on the specific shape of the first matching surface 412.

Referring to FIG. 13, in some embodiments, a detachment guide surface 613 is provided on the first stop surface 611. The detachment guide surface 613 is configured to cooperatively slide relative to the first matching surface 412 when the cleaning member 400 is detached. Due to relative sliding between the assembling guide surface 612 and the matching hole 411, the first matching surface 412 fits the first stop surface 611, so that the supporting member 600 can be installed into the matching hole 411 successfully. The assembling guide surface 612 may be an arc surface or an inclined surface, and embodiments of the present disclosure do not impose specific limitations on the specific shape of the assembling guide surface 612.

Referring to FIG. 12 and FIG. 14, in some embodiments, when “the first matching surface 412 and the second matching surface 413 are formed on two opposite sides of the matching protrusion 410”, the second matching surface 413 is disposed at an end of the matching protrusion 410 close to the driving member 200, and a second stop surface that fits the second matching surface 413 is formed on the supporting member 600. Due to fitting between the second matching surface 413 and the second stop surface, sliding of the supporting member 600 in the matching hole 411 is limited. When being installed, the supporting member 600 extends into an assembling hole until the second matching surface 413 fits the second stop surface. Due to fitting between the second matching surface 413 and the second stop surface, an installation position of the supporting member 600 in the assembling hole can be determined fast, thereby improving assembling efficiency. A distance between the first matching surface 412 and the second matching surface 413 is equal to a distance between the first stop surface 611 and the second stop surface, so that stability of connection between the supporting member 600 and the cleaning member 400 is improved.

Referring to FIG. 12 and FIG. 14, in some embodiments, the stop member 610 is provided with an assembling guide surface 612; and the smallest angle between the assembling guide surface 612 and the axial direction of the cleaning member 400 is an acute angle.

Referring to FIG. 12 and FIG. 14, in some embodiments, a rebound space 620 for the stop member 610 is formed on the supporting member 600. When a force is applied, the detachment guide surface 613 and the first matching surface 412 slide relative to each other, and the stop member 610 retracts into the rebound space 620, so that the supporting member 600 can be taken out of the matching hole 411 successfully.

Referring to FIG. 12 and FIG. 14, in some embodiments, a minimum distance between an inner wall of the rebound space 620 and the driving member 200 is less than a distance between the first matching surface 412 and the driving member 200, so that an end of the stop member 610 away from the driving member 200 is disposed in a suspended manner. Further, the stop member 610 is elastic, so that the stop member 610 can retract into the rebound space 620 conveniently when being stressed.

Referring to FIG. 12 and FIG. 15, in some embodiments, the supporting member 600 is provided with a limiting part 640. The limiting part 640 is disposed among a plurality of stop members 610, and gaps are formed between the limiting part 640 and the stop members 610. After retracting into the rebound space 620 until the stop member 610 is abutted with the limiting part 640. A degree by which the stop member 610 retracts can be limited by the limiting part 640, so that fracture caused by overbending of the stop member 610 can be avoided.

In some embodiments, the stop member 610 is at least partially elastic, so that the stop member 610 in the rebound space 620 can return to its original position conveniently. The stop member 610 may be completely or partially elastic, which is not particularly limited in embodiments of the present disclosure.

In some embodiments, referring to FIG. 12 and FIG. 13, at least two stop members 610 are disposed; and the stop members 610 are distributed in a circumferential direction of the supporting member 600 to facilitate matching between the stop member 610 and the matching hole 411.

In some embodiments, referring to FIG. 12 and FIG. 13, two stop members 610 are disposed and a rebound space 620 is formed between the stop members 610 on two opposite sides. In a procedure of installing or detaching the cleaning member 400, the stop members 610 are bent towards opposite sides when a force is applied. Because the rebound space 620 is between the two stop members 610 on the two opposite sides, the stop members 610 may retract into the rebound space 620, to ensure that the cleaning member 400 can be installed or detached smoothly. In addition, because the rebound space 620 is formed between the stop members 610 on the two opposite sides, volume of the rebound space 620 is increased to the most extent, to ensure that the stop members 610 can move more flexibly.

In some embodiments, referring to FIG. 12 and FIG. 13, the stop member 610 is provided with a sliding groove 650, and the sliding groove 650 may be in slide fit with the matching protrusion 410. Because the sliding groove 650 is in slide fit with the matching protrusion 410, matching between the cleaning member 400 and the supporting member 600 is more smooth.

In some embodiments, referring to FIG. 12 and FIG. 13, in a section perpendicular to the cleaning member 400, the sliding groove 650 and the matching protrusion 410 are both arc-shaped, so that sliding resistance between the sliding groove 650 and the matching protrusion 410 can be reduced, thereby improving detaching and installing efficiency.

When the cleaning member 400 is moved to the second position, as shown in FIG. 29, the cleaning member 400 is separated from the driving mechanism, that is, when the cleaning member 400 enters the to-be-detached state, the cleaning member 400 is in separable fit with the driving mechanism, so that a phenomenon that the cleaning member 400 rotates relative to the housing 100 when being detached is avoided, to reduce a risk that an operator is hurt accidentally by rotation of the cleaning member 400 during detaching of the cleaning member 400. Due to movement of the cleaning member 400, fast connection and separation between the cleaning member 400 and the driving mechanism can be realized while switching of the cleaning member 400 between the working state and the to-be-detached state is implemented, and operation safety is improved.

When the cleaning member 400 is at the second position, the cleaning member 400 can be separated from the driving mechanism. In this case, the cleaning member 400 can be taken off for cleaning or replacement. Similarly, when the cleaning member 400 is at the second position, installing of a cleaned or replaced cleaning member 400 can be completed only by installing the cleaning member 400 on the driving mechanism. When the cleaning member 400 is at the second position, the cleaning member 400 can rotate relative to the driving mechanism. The cleaning member 400 can be moved away from an installation position via simple rotation, so that detaching operation of the cleaning member 400 does not need to be limited to the narrow installation position.

The cleaning apparatus provided in this embodiment of the present disclosure further includes a support 300. Referring to FIG. 30 and FIG. 31, the cleaning member 400 is installed on the support 300; and the support 300 performs a function of supporting the cleaning member 400.

In some embodiments, referring to FIG. 30 and FIG. 31, the housing is provided with an accommodating groove 110 for the cleaning member 400; and the support 300 rotates in a direction from inside of the accommodating groove 110 to outside of the accommodating groove 110 (for example, the direction e in FIG. 31). Due to rotation of the support 300, the cleaning member 400 moves from the inside of the accommodating groove 110 to the outside of the accommodating groove 110, so that spatial limitation during detaching is reduced; the cleaning member 400 is prevented from collision with an inner wall of the accommodating groove 110 or other parts in the accommodating groove 110 when being detached; and detaching difficulty is reduced. When the cleaning member 400 is in the working state, the cleaning member 400 is partially located in the accommodating groove 110, that is, the accommodating groove 110 is the installation position of the cleaning member 400. The accommodating groove 110 provides physical protection for the cleaning member 400. Moreover, the accommodating groove 110 provides necessary mechanical support and firmness for the cleaning member 400, so that the cleaning member 400 can rotate at an appropriate position.

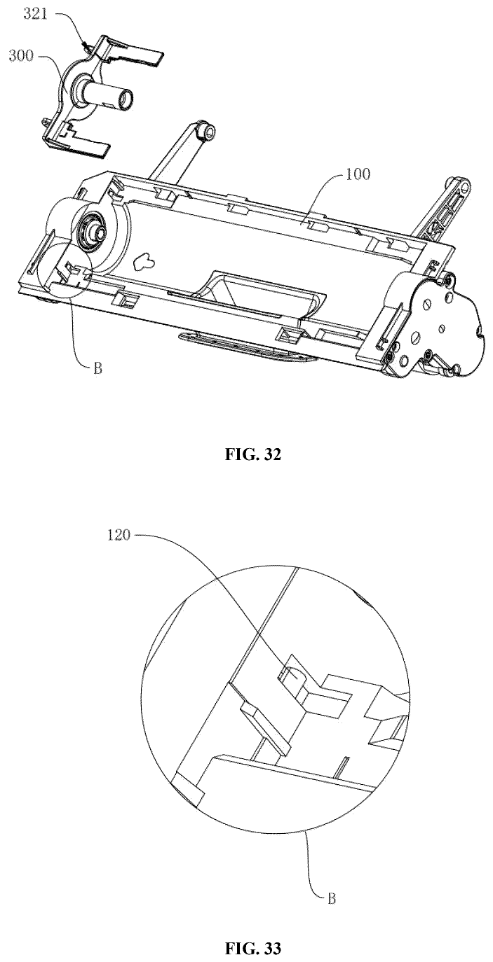

In some embodiments, one of the support 300 and the housing 100 is provided with a movable shaft 120, and the other one of the support 300 and the housing 100 is provided with a matching groove 321; and the movable shaft 120 moves inside the matching groove 321, so that the support 300 switches between the first position and the second position. For example, referring to FIG. 32 and FIG. 33, the housing 100 is provided with a movable shaft 120; and the support 300 is provided with a matching groove 321.

Due to movement of the movable shaft 120 inside the matching groove 321, relative displacement between the support 300 and the housing 100 is realized, which facilitates detaching of the cleaning member 400. In a rotating procedure of the support 300, the movable shaft 120 is limited inside the matching groove 321, that is, a cooperative relationship between the support 300 and the housing 100 is kept all the time. The cleaning member 400 can be moved outside of the installation position by rotating the cleaning member 400, to facilitate detaching of the cleaning member 400. The cleaning member 400 installed on the support 300 can be moved to the installation position by moving the cleaning member 400 to the first position, so that after being detached, the cleaning member 400 can then be installed to the installation position fast and accurately, and a installing speed of the cleaning member 400 is accelerated.

Alternatively, in other embodiments, the movable shaft 120 may be disposed on the support 300; and the matching groove 321 may be disposed on the housing 100, and embodiments of the present disclosure do not impose specific limitations on this.

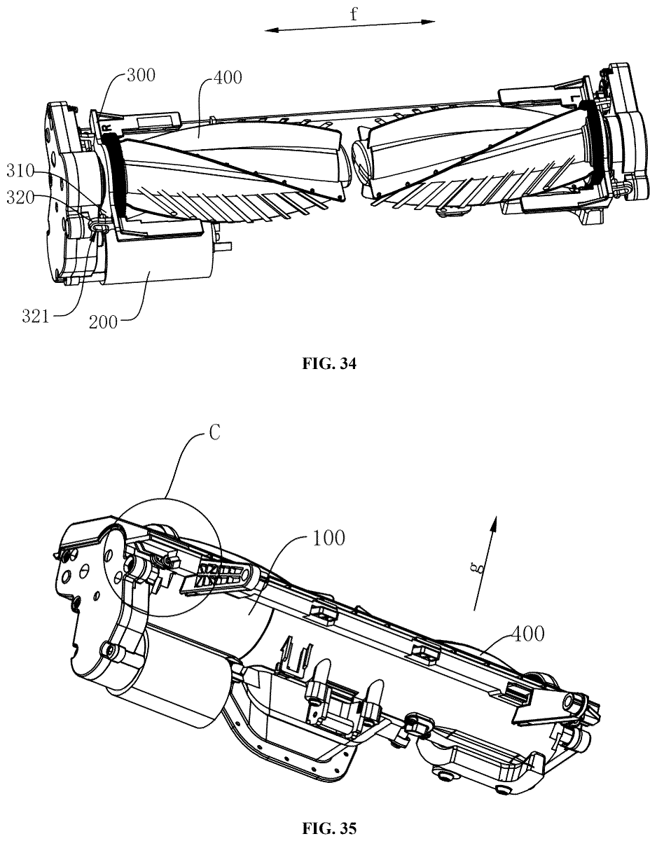

In some embodiments, referring to FIG. 34, the matching groove 321 extends along the direction of the rotating axis of the cleaning member 400 (for example, the direction f in FIG. 34), so that when the movable shaft 120 moves inside the matching groove 321, the cleaning member can rotate around the movable shaft 120. The cleaning members on the left and right sides do not interfere with each other when the cleaning members are disposed obliquely upward, the cleaning members 400 on the support 300 may be close to or away from the driving member 200 to connect the cleaning members 400 to the driving shaft of the driving member 200 or separate the cleaning members 400 from the driving shaft of the driving member 200.

In some embodiments, referring to FIG. 34, an end of the matching groove 321 is provided with an arc-shaped inner wall to fit an arc-shaped outer surface of the movable shaft 120, facilitating the support 300 to rotate around the movable shaft 120 that serves as a rotating center.

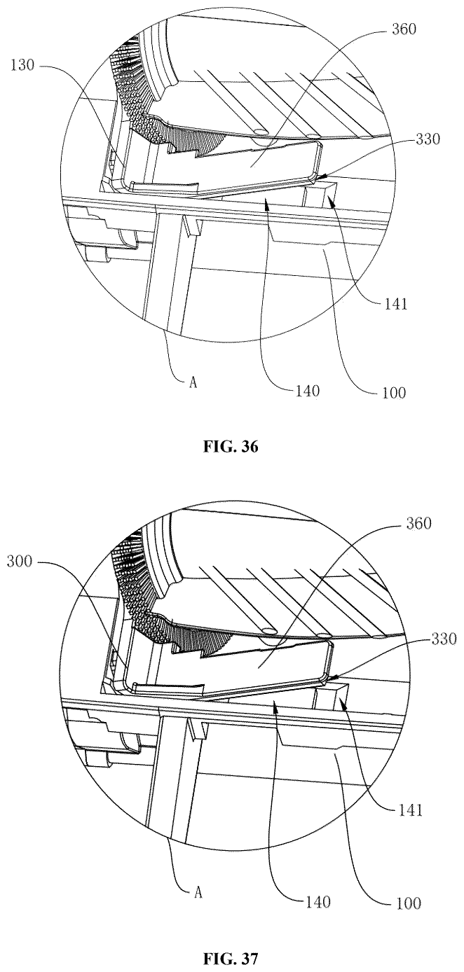

In some embodiments, referring to FIG. 34 and FIG. 35, an end of the matching groove 321 away from the cleaning member 400 is inclined towards a direction away from the housing 100 (for example, the direction g in FIG. 35), so that the end of the matching groove 321 away from the cleaning member 400 may match a rotating path of the support 300, making a rotating procedure of the support 300 more smooth.

In some embodiments, referring to FIG. 34 and FIG. 35, the support 300 includes a base 310 and a connecting lug 320; the connecting lug 320 is disposed on the base 310 in a protruding manner; and the matching groove 321 is formed in the connecting lug 320. Therefore, during installation, a position of the matching groove 321 can be determined fast to accelerate an installation speed. In addition, compared with directly forming the matching groove 321 in the base 310, the connecting lug 320 is disposed on the base 310 in a protruding manner in this embodiment of the present disclosure, which ensures that the support 300 can avoid the housing 100 or another component installed on the housing when rotating. This makes rotation of the support 300 relatively flexible.

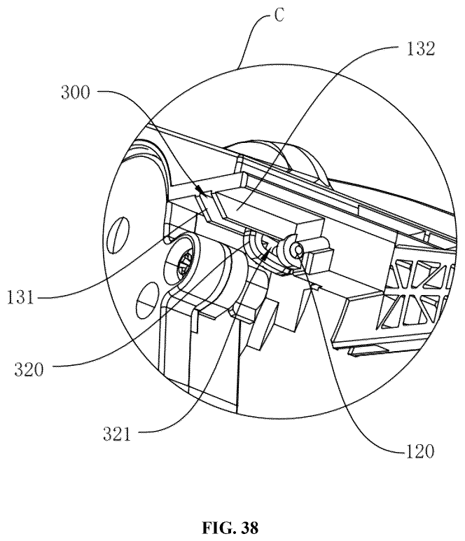

In some embodiments, referring to FIG. 35 and FIG. 38, a fixing groove 130 for the connecting lug 320 is formed in the housing 100, so that the connecting lug 320 can be limited in the fixing groove 130 to reduce shake of the connecting lug 320 when the support 300 rotates. Therefore, rotating stability of the support 300 is improved. The movable shaft 120 penetrates through a side wall of the fixing groove 130. When the connecting lug 320 moves in the fixing groove 130, the movable shaft 120 moves within the matching groove 321, which implements matching between the movable shaft 120 and the matching groove 321. For example, the fixing groove 130 is provided with a first side wall 131 and a second side wall 132 that are disposed oppositely. The connecting lug 320 is between the first side wall 131 and the second side wall 132, while the rotating axis penetrates through the first side wall 131, the matching groove 321 and the second side wall 132 sequentially. When the connecting lug 320 moves between the first side wall 131 and the second side wall 132, a relative displacement occurs between the movable shaft 120 and the matching groove 321, thereby implementing switching of the support 300 between the first position and the second position. Two connecting lugs 320 may be disposed, to ensure rotating stability of the support 300. The number of the connecting lugs 320 is not particularly limited in embodiments of the present disclosure.

In some embodiments, referring to FIG. 36 and FIG. 37, the housing 100 is provided with a positioning groove 140; and the support 300 is provided with a positioning part 360. The positioning part 360 is at least partially located in the positioning groove 140 when the support 300 is at the first position. The positioning groove 140 limits movement of the positioning part 360, so that the support 300 is kept at the first position to ensure normal operation of the cleaning member 400. The positioning part 360 may be partially or completely located in the positioning groove 140, as long as the positioning groove 140 can limit movement of the positioning part 360. A shape of the positioning groove 140 may match a shape of the positioning part 360 to better fix the positioning part 360.

The positioning part 360 is connected onto the base 310. The positioning groove 140 may be communicated with the fixing groove 130, to facilitate manufacturing. Two positioning parts 360 are disposed, and the two positioning parts 360 provide an enhanced fixing effect for the support 300.

In some embodiments, referring to FIG. 36 and FIG. 37, the positioning groove 140 is provided with a first guide surface 141; and the support 300 slides out of the positioning groove 140 through the first guide surface 141. Due to relative sliding between the first guide surface 141 and the positioning part 360, the difficulty for the support 300 to slide out of the positioning groove 140 can be reduced, which facilitates switching of the support 300 from the first position to the second position. The first guide surface 141 may be an arc surface or an inclined surface, and embodiments of the present disclosure do not impose specific limitations on the specific shape of the first guide surface 141. The first guide surface 141 is disposed at a side of the positioning groove 140 away from the rotating center of the support 300, that is, the first guide surface 141 is disposed at a side of the positioning groove 140 away from the matching groove 321.

In some embodiments, referring to FIG. 36 and FIG. 37, the positioning part 360 is provided with a second guide surface 330; and the support 300 slides out of the positioning groove 140 through the second guide surface 330. Due to relative sliding between the second guide surface 330 and the positioning groove 140, the difficulty for the support 300 to slide out of the positioning part 360 can be reduced, which facilitates switching of the support 300 from the first position to the second position. The second guide surface 330 may be an arc surface or an inclined surface, and embodiments of the present disclosure do not impose specific limitations on the specific shape of the second guide surface 330. The second guide surface 330 is disposed at a side of the positioning part 360 away from the rotating center of the support 300, that is, the second guide surface 330 is disposed at a side of the positioning part 360 away from the movable shaft 120.

In some embodiments, referring to FIG. 36 and FIG. 37, the positioning groove 140 is provided with a first guide surface 141; and the positioning part 360 is provided with a second guide surface 330. Due to relative sliding between the first guide surface 141 and the second guide surface 330, the difficulty for the support 300 to slide out of the positioning groove 140 can be reduced, which facilitates switching of the support 300 from the first position to the second position.

In some embodiments, referring to FIG. 9, the cleaning apparatus further includes a cover body 500 covering at least part of the positioning groove 140. As the cover body 500 covers the positioning groove 140 to limit the positioning part 360 in the positioning groove 140, the support 300 is kept at the first position to ensure normal operation of the cleaning member 400. The cover body 500 may cover the positioning groove 140 completely or partially, as long as the cover body 500 can prevent the positioning part 360 from sliding out of the positioning groove 140. Before detaching the cleaning member 400, the cover body 500 may be separated from the positioning groove 140, the positioning part 360 slides out of the positioning groove 140, and the cleaning member 400 can be detached from the support 300 by rotating the support 300.

In some embodiments, referring to FIG. 9, an extending part 170 is disposed at an edge of the accommodating groove 110; and the cover body 500 covers the accommodating groove 110 and is connected to the extending part 170 to complete connection between the cover body 500 and the housing 100. Generally, a working window 510 is formed in the cover body 500; and a part of the cleaning member 400 extends out of the working window 510 to perform a cleaning operation. To facilitate machining, the extending part 170 is an extending plate.

In some embodiments, referring to FIG. 14, a connecting part 340 is provided on the support 300, and the connecting part 340 sleeves outside of the supporting member 600. Due to the supporting member 600, the cleaning member 400 can be installed on the support 300. The connecting part 340 sleeves outside of the supporting member 600 to perform a function of supporting the supporting member 600, so that the supporting member 600 is kept stable in a working state. The supporting member 600 is rotatable relative to the connecting part 340, thereby preventing the support 300 from rotating with the rotation of the supporting member 600. To implement relative rotation between the supporting member 600 and the support 300, a bearing may be installed between the supporting member 600 and the support 300, so that the supporting member 600 can rotate smoothly relative to the support 300. The connecting part 340 may be connected onto the base 310.

In some embodiments, referring to FIG. 15, at least two cleaning members 400 are disposed. Due to the plurality of cleaning members 400, an effective cleaning area can be enlarged, and a cleaning effect of the cleaning apparatus is improved. Each cleaning member 400 is provided with a fixed end 430 and a free end 420. The fixed end 430 of the cleaning member 400 is connected to the housing 100 through the support 300. To detach the cleaning member 400, only the fixed end 430 of the cleaning member 400 needs to be detached, which reduces detaching workload. The free end 420 of one cleaning member 400 extends towards another cleaning member 400, which can reduce influence on another cleaning member 400 when a cleaning member 400 is detached, and help keep independence of each cleaning member 400.

The driving member 200 is in transmission connection with each cleaning member 400, and is configured to drive a plurality of cleaning members 400 to rotate relative to the housing 100. As one driving member 200 is used to drive a plurality of cleaning members 400 to rotate relative to the housing 100, the number of driving members 200 can be reduced, thereby reducing space occupied by the driving members 200. Therefore, layout of the cleaning apparatus is more compact to reduce a size of the cleaning apparatus to the most extent. One driving member 200 is used to drive a plurality of cleaning members 400, so that total weight of the driving members 200 can be reduced, which facilitates movement of the cleaning apparatus.

In this embodiment of the present disclosure, one driving member 200 is used to drive a plurality of cleaning member 400 to work, instead of configuring a driving member 200 separately for each cleaning member 400, so that device purchase costs are reduced. Generally, compared with maintaining a plurality of driving members 200, maintaining a single driving member 200 requires less spares and shorter maintenance time. Therefore, it is more economic to dispose a single driving member 200. Using one driving member 200 to drive and control a plurality of cleaning members 400 can also facilitate fault diagnosis of the cleaning apparatus, so that a fault can be found and treated in time. In addition, using a single driving member 200 to drive a plurality of cleaning members 400 can reduce energy loss, improve overall energy efficiency, optimize energy utilization, and reduce energy consumption.

In a working procedure of the cleaning apparatus, the plurality of cleaning members 400 usually perform a motion synchronously. Therefore, using one driving member 200 can ensure that all the cleaning members 400 operate synchronously, so that operating efficiency of the cleaning apparatus is improved. Using one driving member 200 also better facilitates implementation of centralized control and monitoring of the plurality of cleaning members 400, so that the automation degree and response speed of the cleaning apparatus are increased.

Referring to FIG. 15, in this embodiment of the present disclosure, a plurality of transmission members 700 are further included. The transmission members 700 are connected to the cleaning members 400 correspondingly. Under the driving of the driving member 200, each transmission member 700 drives a corresponding cleaning member 400 to rotate.

Through the transmission members 700, power generated by the driving member 200 can be transferred to each cleaning member 400, causing each cleaning member 400 to rotate relative to the housing 100. Therefore, a plurality of cleaning members 400 can be driven to work by using one driving mechanism. The transmission member 700 may use a plurality of gears or belt pulleys having different diameters, so that a rotating speed can be adjusted, and a speed adjusting effect is achieved. Different transmission members 700 may use different reduction gear ratios, so that the plurality of cleaning members 400 rotate at different speeds.

Referring to FIG. 16, in this embodiment of the present disclosure, a linkage member 800 is further included. The linkage member 800 is connected to at least two transmission members 700. As the linkage member 800 is connected to at least two transmission members 700, synchronous motion of a plurality of transmission members 700 can be implemented. The output shaft of the driving member 200 is connected to the linkage member 800. The plurality of transmission members 700 can be driven synchronously by driving the linkage member 800. As the linkage member 800 is connected to the plurality of transmission members 700, the driving member 200 can drive the plurality of transmission members 700 to rotate only by its connection to the linkage member 800. The driving member 200 does not need to be directly connected to a plurality of transmission members 700, so that an installation position of the driving member 200 is more flexible, overall layout of the cleaning apparatus is facilitated, and a structure of the cleaning apparatus is more compact. The linkage member 800 may be a rod body. The plurality of transmission members 700 may be distributed in a length direction of the linkage member 800 (for example, the direction i in FIG. 16), so that the rod-shaped linkage member 800 can save space.

In other embodiments, the output shaft of the driving member 200 may be connected to at least one transmission member 700. The driving member 200 may drive one of the transmission members 700, and then drive another transmission member 700 to perform a motion through the linkage member 800, so that one driving mechanism can drive a plurality of transmission members 700 to perform a motion, and a single driving mechanism can drive a plurality of cleaning members 400 to rotate relative to the housing 100. The output shaft of the driving member 200 may be connected to one, two, three, or four transmission members 700 to ensure rotating stability of the cleaning member 400, which is not limited in this embodiment of the present disclosure.

In other embodiments, the output shaft of the driving member 200 may be connected to the linkage member 800 and at least one transmission member 700, thereby improving power transferring stability and ensuring stable rotation of the cleaning member 400. Generally, the driving member 200 is a motor.

In some embodiments, referring to FIG. 17, the transmission member 700 includes an input wheel 710 and an output wheel 720; the output wheel 720 is connected to the output shaft of the driving member 200; and the input wheel 710 is coupled to the output wheel 720. As the output wheel 720 is coupled to the input wheel 710, the driving member 200 drives the output wheel 720 to rotate.

In some embodiments, referring to FIG. 17 and FIG. 18, the transmission member 700 includes a first transmission member 730; the first transmission member 730 includes a first input wheel 731 and two first output wheels 732; the first input wheel 731 is connected to the driving shaft of the driving member 200; one of the first output wheels 732 is connected to the corresponding cleaning member 400; and the other first output wheel 732 is connected to the linkage member 800. The driving shaft of the driving member 200 is connected to the first output wheels 732, so that the first transmission member 730 is connected to the driving member 200, and then, the first transmission member 730 drives the linkage member 800 and the cleaning member 400 corresponding to the first transmission member 730 to rotate. The first input wheel 731 is coupled to one of the first output wheels 732. One of the first output wheels 732 is coupled to the other first output wheel 732. The first input wheel 731 may drive a corresponding cleaning member 400 to rotate. Moreover, the first input wheel 731 may also drive another cleaning member 400 to rotate through the linkage member 800, so that a plurality of cleaning members 400 can rotate relative to the housing 100. In other embodiments, the first input wheel 731 may alternatively be coupled to the two first output wheels 732, thereby driving the two first output wheels 732 to rotate.

Referring to FIG. 18 and FIG. 19, the transmission member 700 may further include a second transmission member 740; the second transmission member 740 includes a second input wheel 741 and a second output wheel 742; the second input wheel 741 is connected to the linkage member 800; the second output wheel 742 is connected to a corresponding cleaning member 400; and the second input wheel 741 is coupled to the second output wheel 742. As the second output wheel 742 is coupled to the second input wheel 741, the corresponding cleaning member 400 can rotate.

Referring to FIG. 20, the embedding groove 721 may be formed in the output wheel 720, so that the output wheel 720 can drive a corresponding cleaning member 400 to rotate.

In some embodiments, referring to FIG. 21, two transmission members 700 are disposed. The two transmission members 700 are provided at two opposite sides of the housing 100; and one end of the linkage member 800 is connected to one transmission member 700 and the other end of the linkage member 800 is connected to another transmission member 700. As the transmission members 700 are disposed at two opposite sides of the housing 100, energy lost when the linkage member 800 transfers power can be reduced. Moreover, the linkage member 800 can ensure synchronous motion of the transmission members 700 at the two sides of the housing 100. As the transmission members 700 on two opposite sides of the housing 100 are connected through the linkage member 800, power and torque can be distributed in the entire cleaning apparatus more uniformly, thereby reducing stress concentration, and prolonging service lives of the transmission members 700 and the linkage member 800. As the transmission members 700 are disposed at two opposite sides of the housing 100, risks of vibration and imbalance that may be caused by a transmission member 700 disposed on a single side are reduced, and the entire cleaning apparatus is enabled to run more smoothly and reliably.

In some embodiments, referring to FIG. 21, the output shaft of the driving member 200 is disposed along a direction of a rotating axis of the cleaning member 400. Because the driving member 200 is generally strip-shaped, and its length direction is an extending direction of the output shaft of the driving member 200, the output shaft of the driving member 200 is disposed along a direction of the rotating axis of the cleaning member 400 to reduce a size of the driving member 200 in a vertical direction (for example, the direction j in FIG. 21), thereby reducing a size of the cleaning apparatus in the vertical direction, and facilitating miniaturization and flattening of the cleaning apparatus. The rotating axis of the cleaning member 400 is a rotating axis of the cleaning member 400 in a working state. The vertical direction is a height direction of the cleaning apparatus in the working state.

In some embodiments, referring to FIG. 21, a plurality of transmission members 700 are separately disposed at ends of the housing 100, so that inner space of the cleaning apparatus can be utilized more efficiently, thereby making a structure of the cleaning apparatus more compact, and facilitating miniaturization of the cleaning apparatus. As the transmission members 700 are disposed at the ends of the housing 100, the transmission members 700 can be installed, maintained, and repaired more conveniently, and maintenance personnel can examine the transmission members 700 faster.

In some embodiments, referring to FIG. 22, installation grooves 160 for the transmission members 700 are formed at ends of the housing 100. The installation grooves 160 can provide functions of positioning and aligning the transmission members 700, which ensures that the transmission members 700 can be installed on the housing 100 correctly, and are prevented from getting loose or falling off from their positions.

In some embodiments, referring to FIG. 22, the housing 100 is provided with a dust collection opening 150. After sweeping is performed, dust on the cleaning member 400 may be collected through the dust collection opening 150. The dust collection opening 150 is disposed between two cleaning members 400, which can reduce shielding of the dust collection opening 150 by the cleaning members 400. Therefore, dust can enter the dust collection opening 150 smoothly after sweeping. The dust collection opening 150 may be communicated with a dust collection component that may collect impurities such as dust. The dust collection component may be a dust collection bag or a dust collection box. The dust collection component may be provided with a dust suction component thereon, for example, a fan. The dust suction component may provide power for flowing of impurities such as dust.

In some embodiments, a guide plate (not shown in the figure) is disposed on the housing 100 and is suitable for directing impurities to the dust collection opening 150. The guide plate performs a directing function, and may guide impurities into the dust collection opening 150.

An embodiment of the present disclosure provides a cleaning system, including a base station and the foregoing detachable cleaning member(s) or the foregoing cleaning apparatus.

It may be understood that the detachable cleaning member(s) and the cleaning apparatus have beneficial effects of the foregoing embodiments. Correspondingly, the cleaning system has the beneficial effects of the foregoing embodiments. For specific implementations, reference may be made to the foregoing embodiments. Details are not described in this application again.

The present disclosure aims at at least to certain extent solving the technical problem of a too large volume of the entire cleaning apparatus due to a plurality of driving mechanisms. The present disclosure provides a cleaning apparatus and a cleaning system, which are capable of driving a plurality of cleaning members simultaneously and reducing the volume of the entire cleaning apparatus.

Embodiments of the present disclosure provide a cleaning apparatus. The cleaning apparatus includes:
a housing;
a plurality of cleaning members all installed in the housing; and
a driving mechanism in direct or transmission connection with the cleaning members, wherein the driving mechanism is configured to drive the plurality of cleaning members to perform a motion relative to the housing, and includes at least one driving member, wherein the driving member is disposed on the housing, and the number of the at least one driving member is smaller than the number of the cleaning members.

In some embodiments, the driving mechanism includes at least one transmission member, the driving member is installed on the housing, and the transmission member is correspondingly connected to the cleaning member, and the transmission member drives the corresponding cleaning member to perform a motion under the driving of the driving member.

In some embodiments, the driving mechanism further includes a linkage member connected to at least two transmission members; and an output shaft of the driving member is connected to the linkage member and/or the at least one transmission member.

In some embodiments, two transmission members are disposed on two opposite sides of the housing; one end of the linkage member is connected to one of the transmission members and the other end of the linkage member is connected to the other one of the transmission members.

In some embodiments, the at least one transmission member includes a first transmission member, the first transmission member includes a first input wheel and two first output wheels, wherein the first input wheel is connected to a driving shaft of the driving member, one of the first output wheels is connected to the corresponding cleaning member, and the other one of the first output wheels is connected to the linkage member; the first input wheel is coupled to at least one of the first output wheels, and the first output wheel is coupled to the first input wheel and/or the other one of the first output wheels.

In some embodiments, the transmission member includes an input wheel and an output wheel, wherein the output wheel is connected to an output shaft of the driving mechanism, the input wheel is coupled to the output wheel, and an end surface of the output wheel is provided with an embedding groove; and the cleaning member is provided with a supporting member detachably connected into the embedding groove.

In some embodiments, the output wheels connected to the different cleaning members have the same rotating speed.

In some embodiments, an output shaft of the driving mechanism is disposed along a direction of a rotating axis of the cleaning member.

In some embodiments, the plurality of transmission members are disposed at ends of the housing respectively.

In some embodiments, installation grooves for the transmission members are formed at the ends of the housing.

In some embodiments, the cleaning apparatus further includes a cover body, wherein an accommodating groove for the cleaning members is formed in the housing, an extending part is disposed at an end of the accommodating groove, and the cover body covers the accommodating groove and is connected to the extending part.

In some embodiments, at least two cleaning members are disposed; and a fixed end of one of the cleaning members is connected onto the housing and an extending direction from the fixed end of one cleaning member to a free end of the cleaning member points to the other cleaning member.

In some embodiments, the housing is provided with a dust collection opening; and a region between two cleaning members overlaps with at least part of the dust collection opening in axial directions of the cleaning members.

In some embodiments, a guide plate is disposed on the housing and is suitable for directing an impurity to the dust collection opening.

Embodiments of the present disclosure provide a cleaning system. The cleaning system includes a base station and the cleaning apparatus described above.

The above embodiments of the present disclosure at least have the following beneficial effects.

By driving a larger number of cleaning members by a smaller number of driving members to perform a motion relative to the housing, the number of the driving members and thus an occupied space of the driving members can be reduced, so that the layout of the cleaning apparatus is more compact, thereby minimizing the volume of the cleaning apparatus. Since a smaller number of driving members drive a larger number of cleaning members, the overall weight of the driving members can be reduced and it is convenient to move the cleaning apparatus.

For the technical problem that it is difficult to clean or replace cleaning members, embodiments of the present disclosure further provide a cleaning apparatus, a cleaning device and a cleaning system, which facilitates cleaning or replacement of the cleaning member after the cleaning member is detached.

Embodiments of the present disclosure provide a cleaning apparatus. The cleaning apparatus includes:
a housing;
a driving member disposed in the housing;
a support rotatable relative to the housing; and
a cleaning member which rotates relative to the housing under the action of the driving member, wherein the cleaning member is installed on the support; and
wherein the support is rotatable between a first position and a second position; the cleaning member is connected to a driving shaft of the driving member when the support is at the first position; the cleaning member is separated from the driving shaft of the driving member when the support rotates to the second position; and the cleaning member is separable from the support when the support is at the second position.

In some embodiments, the housing is provided with an accommodating groove for the cleaning member, and the support rotates in a direction from the inside of the accommodating groove to the outside of the accommodating groove.

In some embodiments, one of the support and the housing is provided with a movable shaft, and the other one of the support and the housing is provided with a matching groove; and the movable shaft moves inside the matching groove so that the support switches between the first position and the second position.

In some embodiments, the matching groove extends along a direction of a rotating axis of the cleaning member.

In some embodiments, an end of the matching groove away from the cleaning member is inclined towards a direction away from the housing.

In some embodiments, the support includes a base and a connecting lug; the connecting lug is disposed on the base in a protruding manner; and the matching groove is formed in the connecting lug.

In some embodiments, a fixing groove for the connecting lug is formed in the housing, and the movable shaft penetrates through a side wall of the fixing groove.

In some embodiments, the housing is provided with a positioning groove; the support is provided with a positioning part; and the positioning part is at least partially located in the positioning groove when the support is located at the first position.

In some embodiments, the positioning groove is provided with a first guide surface, and the support is slidable out of the positioning groove through the first guide surface.

In some embodiments, the positioning part is provided with a second guide surface, and the support is slidable out of the positioning groove through the second guide surface.

In some embodiments, the cleaning apparatus further includes a cover body covering at least part of the positioning groove.

In some embodiments, the cleaning apparatus further includes a supporting member, wherein the driving member is provided with an embedding groove; the cleaning member is provided with a matching hole therein; and one end of the supporting member penetrates through the matching hole and the other end of the supporting member is detachably connected into the embedding groove.

In some embodiments, the support is provided with a connecting part; the connecting part sleeves outside of the supporting member and the supporting member is rotatable relative to the connecting part.

In some embodiments, at least two cleaning members are disposed, a fixed end of the cleaning member is connected onto the housing through the support, and a free end of one cleaning member extends towards another cleaning member.

In some embodiments, the housing is provided with a dust collection opening disposed between two cleaning members.

In some embodiments, a guide plate is disposed on the housing and is suitable for directing an impurity to the dust collection opening.

Embodiments of the present disclosure provide a cleaning device including the cleaning apparatus described above.

Embodiments of the present disclosure provide a cleaning system including the cleaning apparatus or the cleaning device described above.

The above embodiments of the present disclosure at least have the following beneficial effects.

By switching the support between the first position and the second position, the cleaning member switches between a working state and a detachment state. The cleaning member is connected to the driving shaft of the driving member when the support is at the first position, so that the cleaning member rotates relative to the housing under the action of the driving member so as to complete the cleaning operation. The cleaning member is separable from the support when the support is at the second position, so that the cleaning member is removed for replacement or cleaning. When the support rotates to the second position, since the cleaning member is separated from the driving shaft of the driving member, the situation that the cleaning member rotates when being detached to accidentally injure an operator can be avoided, thereby improving the safety performance.

For solving to certain extent the technical problem that it is difficult to clean or replace cleaning members, the present disclosure also provides a detachable cleaning member, which is convenient to clean or replace after being detached.

The present disclosure further discloses a cleaning apparatus.

The present disclosure further discloses a cleaning system.

Embodiments of the present disclosure provide a detachable cleaning member. The detachable cleaning member includes:
a free end and a fixed end, the fixed end being detachably connected to a driving mechanism; wherein the cleaning member is rotatable under the action of the driving mechanism; and
wherein the cleaning member is provided with a matching hole therein, and the driving mechanism at least partially penetrates through the matching hole; at least one matching protrusion is disposed in the matching hole; and the matching protrusion is separably connected to the driving mechanism.

Embodiments of the present disclosure provide a cleaning apparatus. The cleaning apparatus includes a driving mechanism and the detachable cleaning member described above.

Embodiments of the present disclosure provide a cleaning system. The cleaning system includes a base station and the detachable cleaning member described above or the cleaning apparatus described above.

The embodiments of the present disclosure at least have the following beneficial effects.

The cleaning member can be detached for cleaning or replacement by only detaching the fixed end of the cleaning member, which can reduce the workload of detachment and facilitate detachment while ensuring the normal operation of the cleaning member. As the cleaning member is provided with the matching hole therein, and the matching protrusion is separably connected to the driving mechanism, the reliability of the connection between the cleaning member and the driving mechanism can be improved through the matching protrusion and it is convenient to detach the cleaning member.

In the present disclosure, unless expressly specified and defined otherwise, a first feature being “on” or “below” a second feature may include direct contact between the first and second features, or may include that the first and second features may not be in direct contact, but in contact by means of another feature. Moreover, the first feature being “on” or “above” or “over” the second feature includes the first feature being directly above and obliquely above the second feature, or simply means that the horizontal height of the first feature is higher than that of the second feature. The first feature being “beneath” or “below” or “under” the second feature includes the first feature being directly below and obliquely below the second feature, or simply means that the horizontal height of the first feature is lower than that of the second feature.

It should be noted that all directional indications in embodiments of the present disclosure are merely used to explain a relative position relationship, motion conditions, and the like of the components in a specific gesture. If the specific gesture changes, the directional indication changes accordingly.

In the present disclosure, unless expressly specified and defined otherwise, terms such as “connect” and “fasten” should be interpreted in a broad sense. For example, “fasten” may mean a fixed connection, a detachable connection, or an integral connection; may mean a mechanical connection or an electrical connection; or may mean a direct connection, an indirect connection by means of an intermediate object, internal communication between two elements, or an interaction between two elements, unless otherwise defined. Those of ordinary skill in the art may understand specific meanings of the above terms in the present disclosure based on specific situations.

Moreover, terms such as “first” and “second” described in the present disclosure are used herein only for the purpose of description and cannot be understood as indicating or implying their relative importance or implicitly indicating a quantity of indicated technical features. Therefore, a feature limited by “first” or “second” may explicitly or implicitly include one or more features. In the descriptions of the present disclosure, “a plurality of” means two or more, unless otherwise specifically limited.

Although embodiments of the present disclosure have been introduced and described, those of ordinary skill in the art may understand that various changes, modifications, replacements, and variants may be made to these embodiments without departing from the principle and purpose of the present disclosure, and the scope of the present disclosure is limited by the claims and their equivalents.

What is claimed is:

1. A cleaning apparatus, comprising:
a housing;
a plurality of cleaning members installed in the housing; and
a driving mechanism in direct or transmission connection with the plurality of cleaning members, wherein the driving mechanism is configured to drive the plurality of cleaning members to perform a motion relative to the housing, and comprises at least one driving member, wherein the driving member is disposed on the housing, and the number of the at least one driving member is smaller than the number of the cleaning members.

2. The cleaning apparatus according to claim 1, wherein the driving mechanism comprises at least one transmission member, the driving member is installed on the housing, and the transmission member is correspondingly connected to the cleaning member; and
wherein the transmission member drives a corresponding cleaning member to perform a motion under driving of the driving member;
wherein the driving mechanism further comprises a linkage member connected to at least two transmission members; and
wherein an output shaft of the driving member is connected to the linkage member and/or the at least one transmission member;
wherein the at least one transmission member comprises two transmission members, and the two transmission members are disposed on two opposite sides of the housing;
wherein one end of the linkage member is connected to one of the transmission members and the other end of the linkage member is connected to the other one of the transmission members;
or, wherein the at least one transmission member comprises a first transmission member, the first transmission member comprises a first input wheel and two first output wheels,
wherein the first input wheel is connected to a driving shaft of the driving member, one of the first output wheels is connected to the corresponding cleaning member, and the other one of the first output wheels is connected to the linkage member;
wherein the first input wheel is coupled to at least one of the first output wheels, and the first output wheel is coupled to the first input wheel and/or the other one of the first output wheels.

3. The cleaning apparatus according to claim 2, wherein the transmission member comprises an input wheel and an output wheel, wherein the output wheel is connected to an output shaft of the driving mechanism, the input wheel is coupled to the output wheel, and an end surface of the output wheel is provided with an embedding groove; and
wherein the cleaning member is provided with a supporting member detachably connected into the embedding groove;
wherein output wheels connected to the different cleaning members have the same rotating speed;
wherein an output shaft of the driving mechanism is disposed along a direction of a rotating axis of the cleaning member.

4. The cleaning apparatus according to claim 2, wherein a plurality of transmission members are disposed at ends of the housing respectively;
wherein installation grooves for the transmission members are formed at the ends of the housing;
or, wherein at least two cleaning members are provided; and
wherein a fixed end of one of the cleaning members is connected onto the housing and an extending direction from the fixed end of the cleaning member to a free end of the cleaning member points to the other cleaning member.

5. The cleaning apparatus according to claim 1, wherein the cleaning apparatus further comprises: a support rotatable relative to the housing,
wherein the cleaning member rotates relative to the housing under action of the driving member, and the cleaning member is installed on the support; and
wherein the support is rotatable between a first position and a second position, the cleaning member is connected to a driving shaft of the driving member when the support is at the first position, and the cleaning member is separated from the driving shaft of the driving member when the support rotates to the second position, and the cleaning member is separable from the support when the support is at the second position.

6. The cleaning apparatus according to claim 5, wherein the housing is provided with an accommodating groove for the cleaning members, and the support rotates in a direction from inside of the accommodating groove to outside of the accommodating groove;
wherein:
one of the support and the housing is provided with a movable shaft, and the other one of the support and the housing is provided with a matching groove; and
the movable shaft moves inside the matching groove so that the support switches between the first position and the second position;
wherein the matching groove extends along a direction of a rotating axis of the cleaning member.

7. The cleaning apparatus according to claim 5, wherein the housing is provided with a positioning groove, the support is provided with a positioning part, and the positioning part is at least partially located in the positioning groove when the support is at the first position;
wherein the positioning groove is provided with a first guide surface, and the support is slidable out of the positioning groove through the first guide surface;
wherein the cleaning apparatus further comprises a cover body covering at least part of the positioning groove;
wherein the cleaning apparatus further comprises a supporting member,
wherein the driving member is provided with an embedding groove, a matching hole is provided inside the cleaning member, and one end of the supporting member penetrates through the matching hole, and the other end of the supporting member is detachably connected into the embedding groove;
wherein the support is provided with a connecting part, the connecting part sleeves outside of the supporting member and the supporting member is rotatable relative to the connecting part;
wherein at least two cleaning members are disposed, a fixed end of one of the cleaning members is connected onto the housing through the support, and a free end of the cleaning member extends towards another cleaning member.

8. The cleaning apparatus according to claim 1, wherein the cleaning member is a detachable cleaning member, and the detachable cleaning member comprises:
a free end and a fixed end, wherein the fixed end is detachably connected to the driving mechanism, and the cleaning member is rotatable under action of the driving mechanism;
wherein a matching hole is provided inside the cleaning member, and the driving mechanism at least partially penetrates through the matching hole,
wherein at least one matching protrusion is disposed in the matching hole, and the matching protrusion is separably connected to the driving mechanism.

9. The cleaning apparatus according to claim 8, wherein the cleaning member is movable between a first position and a second position relative to the driving mechanism;
wherein the cleaning member is connected to the driving mechanism when the cleaning member is at the first position, and the cleaning member is separable from the driving mechanism when the cleaning member is at the second position;
wherein the cleaning member is movable between the first position and the second position relative to the driving mechanism along an axial direction of the cleaning member;
wherein at least two matching protrusions are disposed, and the matching protrusions are disposed at the same position in an axial direction of the cleaning member.

10. The cleaning apparatus according to claim 8, wherein in an axial direction of the cleaning member, two opposite sides of the matching protrusion form a first matching surface and a second matching surface, and the first matching surface and the second matching surface are suitable for fixing the driving mechanism.

11. The cleaning apparatus according to claim 10, wherein the first matching surface and/or the second matching surface are/is perpendicular to an inner wall of the matching hole.

12. The cleaning apparatus according to claim 8, wherein the driving mechanism comprises a driving member and a supporting member, the supporting member is connected to a driving shaft of the driving member and is disposed in the matching hole;
wherein the first matching surface is disposed at an end of the matching protrusion away from the driving member, a stop member is disposed at an end of the supporting member away from the driving member, and a first stop surface that fits the first matching surface is formed on the stop member.

13. The cleaning apparatus according to claim 12, wherein the first stop surface is provided with a detachment guide surface, the detachment guide surface is configured to cooperatively slide relative to the first matching surface when the cleaning member is detached.

14. The cleaning apparatus according to claim 12, wherein the second matching surface is disposed at an end of the matching protrusion close to the driving member, and a second stop surface that fits the second matching surface is formed on the supporting member.

15. The cleaning apparatus according to claim 13, wherein a rebound space for the stop member is formed on the supporting member.

16. The cleaning apparatus according to claim 12, wherein two stop members are disposed, and a rebound space is formed between the stop members on two opposite sides.

17. The cleaning apparatus according to claim 15, wherein a minimum distance between an inner wall of the rebound space and the driving member is less than a distance between the first matching surface and the driving member.

18. The cleaning apparatus according to claim 12, wherein the supporting member is provided with a limiting part, the limiting part is disposed among a plurality of stop members, and gaps are formed between the limiting part and the stop members.

19. The cleaning apparatus according to claim 12, wherein at least two stop members are disposed, and the stop members are distributed in a circumferential direction of the supporting member.

20. The cleaning apparatus according to claim 12, wherein a size of the supporting member in a length direction of the cleaning member is greater than or equal to half of the length of the cleaning member.
